(19) United States
(12) Patent Application Publication
(10) Pub. No.: US 2015/0172731 A1
(43) Pub. Date: Jun. 18, 2015

(54) METHODS AND APPARATUS FOR PROVIDING ALTERNATE CONTENT

(71) Applicant: Time Warner Cable Enterprises LLC, New York, NY (US)

(72) Inventors: Charles Hasek, Broomfield, CO (US); Norrie Bush, San Antonio, TX (US); Wilfred Jaime Miles, Arvada, CO (US); Glen Hardin, Charlotte, NC (US); Scott Davis, Tega City, SC (US); Todd Bowen, Austin, TX (US)

(21) Appl. No.: 14/133,495

(22) Filed: Dec. 18, 2013

(51) Int. Cl. H04N 21/254; H04N 21/454; H04N 21/4627; H04N 21/45; H04N 21/4545; H04N 7/16; H04N 21/258

(52) U.S. Cl. CPC H04N 21/2541; H04N 7/165; H04N 21/454; H04N 21/25816; H04N 21/25841; H04N 21/4524; H04N 21/4542; H04N 21/45457; H04N 21/4627; H04N 21/25883

(57) ABSTRACT

Methods and apparatus for providing alternate content in a network, such as in the instance where content is restricted. In one embodiment, a server within the network assigns a location identifier to a plurality of client devices and associates the identifier to a location value. The location value is used to register a certain set of the client devices to a given service area. The server in one variant creates one or more lists associating the client devices to location values, and location values to primary and alternate content. The information is published and accessible to other network components. The server receives a request for content from the client device and either references the list or communicates with another server to determine appropriate content to send. Based on the determination, the server transmits the appropriate content to the requesting device.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates generally to the field of delivery of digital data (e.g., text, video, and/or audio) over networks such as content distribution networks and the Internet, and specifically in one exemplary aspect to delivering alternate content within an Internet Protocol (IP) or similar network environment when restricted content is requested.

2. Description of Related Technology

In a traditional content delivery system, video content may be distributed to a user's or subscriber's device, which is associated to a certain geographic area (e.g., a ZIP code). There are various content delivery systems, such as but not limited to, subscriber systems, satellite systems, direct broadcast satellite (DBS) and cable television (CATV) systems. Under certain contractual provisions, specific content may be “blacked out” in certain geographic areas. For example, a sports event may be restricted to areas outside of the local market for ticket sales to the live event. Accordingly, many content delivery systems provide for geographic areas to be selectively blacked out for specific video content.

In the event that a television broadcast is blacked out, the content delivery system provides alternative content to a subscriber during the blacked out event. For example, a CATV operator manually switches to another available signal for the blacked out event As another example, a program provider of the blacked out event provides alternative content from another satellite feed during the blackout In a typical CATV system, an operator sends instructions to the headend site of the CATV system to connect another satellite receiver, or retune the original satellite receiver to the alternate satellite feed during the blackout. Following the blackout, the original satellite receiver may be re-connected or manually tuned back to the primary satellite feed.

In addition to such manual switching arrangements, automatic switching or retiming of satellite receivers during a blackout make use of a remotely retunable receiver, which includes the capability to retune groups of subscribers to different satellite feeds during (and after) a blackout of video content. To achieve flexible control over program blackouts, a receiver retune command message is selectively sent to desired groups of descramblers at CATV satellite downlinks. The retune command message identifies (in a typical implementation) an alternate satellite feed, and a time for which the satellite receiver is to tune to the alternate satellite feed. The receiver stores the retune command, and at the appropriate time retunes the satellite receiver to the identified alternate feed.

In a traditional mobile content delivery system, a mobile device communicates a request for specific content to a network entity (such as e.g., the network headend). The headend requests geographic coordinate location data from the mobile device, or uses global positioning satellites to determine a geographic coordinate point, or the headend uses the mobile device's IP address location. When the geographic coordinate data is available/determined, the headend determines whether the mobile device is in the geographic area to be selectively blacked out for the specific content. If the mobile device is in the selectively blacked out area, then the mobile content delivery system does not send the requested specific content.

However, one challenge the traditional and mobile content delivery systems face are when a subscriber uses a proxy server located outside of the geographic area to make the request for specific content. In this scenario, both systems believe that the device is located in the geographic area of the proxy server (and not the location of where the device is actually registered). The subscriber, by using the proxy server, has circumvented the content delivery systems and is able to watch content that typically would be blacked out for that subscriber.

Another challenge is presented when the subscriber is not located where the device is registered when the subscriber requests content. For example, the subscriber's mobile or client device may be registered on the East coast; however, the subscriber may currently be located on the West coast when requesting the content. In this scenario, the current content delivery systems determine that the device is located on the West coast (by virtue of e.g., the device's connectivity to West coast assets), and will provide the subscriber with the requested content, even though the requested content would have been blacked out if the subscriber were on the East coast.

Furthermore, yet another challenge relates to filling the “blanks” created during blackouts with the appropriate alternate content. Not only must appropriate content be selected (e.g., content that the subscriber is authorized to receive, and which has some appeal or tangency to the subscriber), but it also must be “dovetailed” appropriately with the preceding and following non-blackout content (if any).

Accordingly, improved apparatus and methods are needed to address the foregoing, including precluding subscribers from circumventing the content delivery system by use of e.g., proxy servers, avoiding the perceived disruption of the content delivery service (as it is desirable to seamlessly and transparently replace original content with alternate content during blackout periods), and the ability to collect data regarding the process of providing content to a subscriber.

### SUMMARY

The present disclosure addresses the foregoing needs by providing, inter alia, various embodiments of methods and apparatus for providing content over networks, such as e.g., packet-switched networks.

In a first aspect of the disclosure, a method for associating individual ones of a plurality of locations to a respective plurality of client devices in a content distribution network is disclosed. In one embodiment, the method comprises: (i) assigning one of a plurality of first locations to respective ones of the plurality of client devices accessing the network, (ii) associating individual ones of the plurality of first locations to respective individual ones of a plurality of second locations, (iii) creating a dynamic list, the dynamic list comprising: individual ones of the plurality of client devices; a respective second location to which the individual ones of the plurality of client devices are associated, and an indicator of viewing rights for the individual ones of the plurality client devices based on the respective second location to which each is associated, and (iv) publishing the dynamic list to the network.

In a second aspect of the disclosure, a method for delivering content to a plurality of client devices in a content distribution network is disclosed. In one embodiment, the method comprises: (i) receiving a request for the content from at least one of the plurality of client devices, (ii) determining a first location associated to the requesting client device, (iii) consulting a dynamic list comprising an association of the first location to one of a plurality of second locations, (iv) determining based on the one of the plurality of second locations an appropriate one of a plurality of content to send to the requesting client device, and (v) sending the appropriate one of the plurality of content to the requesting client device.

In a third aspect of the disclosure, an apparatus configured to process data associated with a plurality of substantially portable client devices in a content distribution network and assign a location thereto is disclosed. In one embodiment, the apparatus comprises: a processor; a storage device in data communication with the processor, the storage device comprising at least one computer program, the at least one computer program comprising a plurality of instructions which are configured to, when executed: (i) obtain first data relating to individual ones of the plurality of client devices, (ii) based on the first data, determine a plurality of first locations associated to respective ones of the plurality of client devices, (iii) associate each of the plurality of first locations to a second location, (iv) create a data record configured to indicate appropriate content viewing rights for the second location, and (v) distribute the data record to the network.

In a fourth aspect of the disclosure, a system for delivery of content in a content distribution network is disclosed. In one embodiment, the system comprises a plurality of client devices, at least one of the plurality of client devices configured to request access to the content from a network, and the network configured to: (i) determine a first location for the at least one of the plurality of client devices, (ii) use a dynamic list to cross-reference the first location to a second location, (iii) based on the second location, determine viewership rights of the at least one of the plurality of client devices, and (iv) provide appropriate content to the at least one of the plurality of client devices, the appropriate content being selected based at least in part on the viewership rights.

In a fifth aspect of the disclosure, a computer readable apparatus is disclosed. In one embodiment, the computer readable apparatus comprises a plurality of instructions which are configured to when executed by a processor process data associated with a plurality of substantially portable client devices in a content distribution network and assign a location thereto.

In another embodiment, the computer readable apparatus comprises a plurality of instructions which are configured to when executed by a processor deliver content to a plurality of client devices in a content distribution network. In yet another embodiment, the computer readable apparatus comprises a plurality of instructions which are configured to when executed by a processor associate individual ones of a plurality of locations to a respective plurality of client devices in a content distribution network.

These and other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a functional block diagram illustrating an exemplary content distribution (e.g., cable) network configuration useful with the present disclosure.

FIG. 1a is a functional block diagram illustrating one exemplary HFC cable network headend configuration useful with the present disclosure.

FIG. 1b is a functional block diagram illustrating one exemplary packetized content delivery network architecture useful with the present disclosure.

FIG. 2 is a high-level functional block diagram illustrating an exemplary content distribution network architecture configured in accordance with the present disclosure.

FIG. 2a is a functional block diagram illustrating an another exemplary content distribution network architecture configured in accordance with the present disclosure.

FIG. 2b is a functional block diagram illustrating an exemplary conditioning network architecture configured in accordance with the present disclosure.

FIG. 3 is a messaging flow diagram illustrating an exemplary embodiment of HLS initial tune messaging flow according to the present disclosure.

FIG. 3a is a messaging flow diagram illustrating an exemplary embodiment of HLS event messaging flow according to the present disclosure.

FIG. 4 is a messaging flow diagram illustrating another exemplary embodiment of HSS initial tune messaging flow according to the present disclosure.

FIG. 4a is a messaging flow diagram illustrating another exemplary embodiment of HSS in event messaging flow according to the present disclosure.

FIG. 5 is a logical flow diagram illustrating an exemplary embodiment of a generalized method for registering a client devices and creating a dynamic list according to the present disclosure.

FIG. 6 is a logical flow diagram illustrating an exemplary embodiment of a generalized method for providing appropriate content according to the present disclosure.

FIG. 7 is a functional block diagram illustrating an exemplary network ACS server device according to the present disclosure.

FIG. 8 is graphic representation of a signal flow switch of an exemplary embodiment of legacy architecture of the present disclosure.

All Figures © Copyright 2013 Time Warner Cable, Inc. All rights reserved.

### DETAILED DESCRIPTION

Reference is now made to the drawings wherein like numerals refer to like parts throughout.

As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the terms “client device” and “end user device” include, but are not limited to, set-top boxes (e.g., DSTBs), personal computers (PCs), and minicomputers, whether desktop, laptop, or otherwise, and mobile devices such as handheld computers, PDAs, personal media devices (PMDs), and smartphones.

As used herein, the term “codec” refers to an video, audio, or other data coding and/or decoding algorithm, process or apparatus including, without limitation, those of the MPEG (e.g., MPEG-1, MPEG-2, MPEG-4, etc.), Real (RealVideo, etc.), AC-3 (audio), DiVX, XViD/ViDX, Windows Media Video (e.g., WMV 7, 8, or 9), ATI Video codec, or VC-1 (SMPTE standard 421M) families.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (e.g., BREW), and the like.

Similarly, the terms “Consumer Premises Equipment (CPE)” and “host device” refer without limitation to any type of electronic equipment located within a consumer's or user's premises and connected to a network. The term “host device” refers generally to a terminal device that has access to digital television content via a satellite, cable, or terrestrial network. The host device functionality may be integrated into a digital television (DTV) set. The term “consumer premises equipment” (CPE) includes such electronic equipment such as set-top boxes, televisions, Digital Video Recorders (DVR), gateway storage devices (Furnace), ITV Personal Computers, game consoles, and home digital media devices (e.g., Roku, Sonons, etc.).

As used herein, the term “display” means any type of device adapted to display information, including without limitation: CRTs, LCDs, TFTs, plasma displays, LEDs, incandescent and fluorescent devices. Display devices may also include less dynamic devices such as, for example, printers, e-ink devices, and the like.

As used herein, the term “DOCSIS” refers to any of the existing or planned variants of the Data Over Cable Services Interface Specification, including for example DOCSIS versions 1.0, 1.1, 2.0, 3.0 and 3.1. DOCSIS (version 1.0) is a standard and protocol for internet access using a “digital” cable network. DOCSIS 1.1 is interoperable with DOCSIS 1.0, and has data rate and latency guarantees (VoIP), as well as improved security compared to DOCSIS 1.0. DOCSIS 2.0 is interoperable with 1.0 and 1.1, yet provides a wider upstream band (6.4 MHz), as well as new modulation formats including TDMA and CDMA. It also provides symmetric services (30 Mbps upstream).

As used herein, the term “headend” refers generally to a networked system controlled by an operator (e.g., an MSO or multimedia specific operator) that distributes programming to MSO clientele using client devices. Such programming may include literally any information source/receiver including, inter cilia, free-to-air TV channels, pay TV channels, interactive TV, and the Internet. DSTBs may literally take on any configuration, and can be retail devices meaning that consumers may or may not obtain their DSTBs from the MSO exclusively. Accordingly, it is anticipated that MSO networks may have client devices from multiple vendors, and these client devices will have widely varying hardware capabilities. Multiple regional headends may be in the same or different cities.

As used herein, the terms “Internet” and “internet” are used interchangeably to refer to inter-networks including, without limitation, the Internet.

As used herein, the terms “IP” and “Internet Protocol” refer without limitation to any of the Internet protocols including e.g., IPv4 (RFC-791 (1981), et seq.), and IPv6 (RFC-2460 (1998), et seq.).

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “MSO” or “multiple systems operator” refer to a cable, satellite, or terrestrial network provider having infrastructure required to deliver services including programming and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internees, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the terms “network agent” and “network entity” refers to any network entity (whether software, firmware, and/or hardware based) adapted to perform one or more specific purposes. For example, a network agent or entity may comprise a computer program running in server belonging to a network operator, which is in communication with one or more processes on a CPE or other device.

As used herein, the term “network interface” refers to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), radio frequency tuner (e.g., in-band or OOB, cable modem, etc.), WiFi (802.11a,b,g,n), WiMAX (802.16), PAN (802.15), or IrDA families.

As used herein, the term “node” refers without limitation to any location, functional entity, or component within a network.

As used herein, the term “QAM” refers to modulation schemes used for sending signals over cable networks. Such modulation scheme might use any constellation level (e.g. QPSK, QAM-16, QAM-64, QAM-256 etc.) depending on details of a cable network. A QAM may also refer to a physical channel modulated according to the schemes.

As used herein, the term “server” refers to any computerized component, system or entity regardless of form which is adapted to provide data, files, applications, content, or other services to one or more other devices or entities on a computer network.

As used herein, the term “storage device” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “user interface” refers to, without limitation, any visual, graphical, tactile, audible, sensory, or other means of providing information to and/or receiving information from a user or other entity.

### Overview

In one aspect of the disclosure, methods and apparatus for providing appropriate content in a network are disclosed. In an exemplary embodiment, the network environment includes an Internet Protocol (IP) based network, as well as a cable television or satellite or other “managed” network. Subscriber client devices are registered with a registration server. The registration server collects various types of data, such as from legacy settop box devices which are connected to a Radio Frequency (RF) interface, as well as from non-legacy IP-enabled devices (IPD). At least some of the client devices may also be portable or mobile.

The exemplary embodiments of the presented systems and apparatus enable, inter diet, detection of a blackout event, and distribution of alternate content in place of the blacked-out content to the various different client devices via the aforementioned cable and IP networks. In one implementation, the detection and/or distribution of alternate content is based on the registered geographical location of the client device. This in effect affords seamless and transparent replacement of the first content with second content during blackout periods.

In one exemplary embodiment, the client devices are associated to a virtual device, such as an integrated receiver/decoder (vIRD), which are in turn assigned a geographical identifier. The geographical area of the vIRD are each associated to a particular service area, and the network may then create a dynamically updatable list of content which is blacked-out in certain service areas, and second content to which is provided in the instance of a blackout. The foregoing functionality is accomplished, in one variant, when the network receives a request from the client device for first content. The network determines the location of the client device based on its initial registration to a vIRD. The network then consults the dynamic list cross-referencing the service area of the device to the appropriate content (whether the requested content or second content due to a blackout in the device's service area). Once the appropriate content is determined, the network provides the identified content to the client device.

In another embodiment, the system is further configured to log switches from requested content to alternate content. Accordingly, the system is able to ensure that the schedule was followed, and is further configured to retain a history of the addition of client devices, and of new alternate content options.

Methods of operating the network(s), client devices, and for doing business using the blackout service network referenced above, are also described.

### Detailed Description of Exemplary Embodiments

Exemplary embodiments of the apparatus and methods of the present disclosure are now described in detail. While these exemplary embodiments are described in the context of the previously mentioned hybrid fiber coax (HFC) cable architecture and associated IP networking infrastructure, the general principles and advantages of the disclosure may be extended to other types of networks and architectures. Such other networks or architectures may be broadband, narrowband, wired or wireless, content or data, managed or unmanaged, or otherwise. Hence, the following description is merely exemplary in nature. For example, various aspects of the disclosure may be practiced over a fiber-to-the-home (FTTH) or fiber-to-the-curb (FTTC) system or over future satellite or millimeter wave-based network having two-way capabilities similar to today's digital cable HFC networks.

It will also be appreciated that while described generally in the context of a network providing service to a customer or consumer (i.e., residential) end user domain, the present disclosure may be readily adapted to other types of environments including, e.g., commercial/enterprise, and government/military applications. Myriad other applications are possible.

### Network-Side Architecture

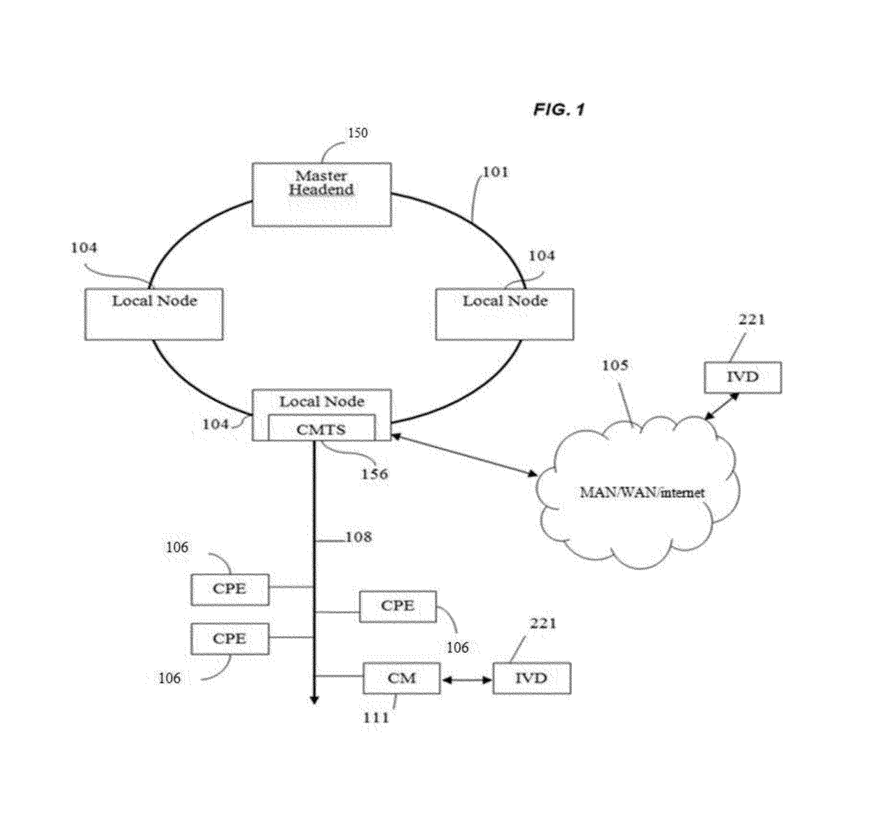

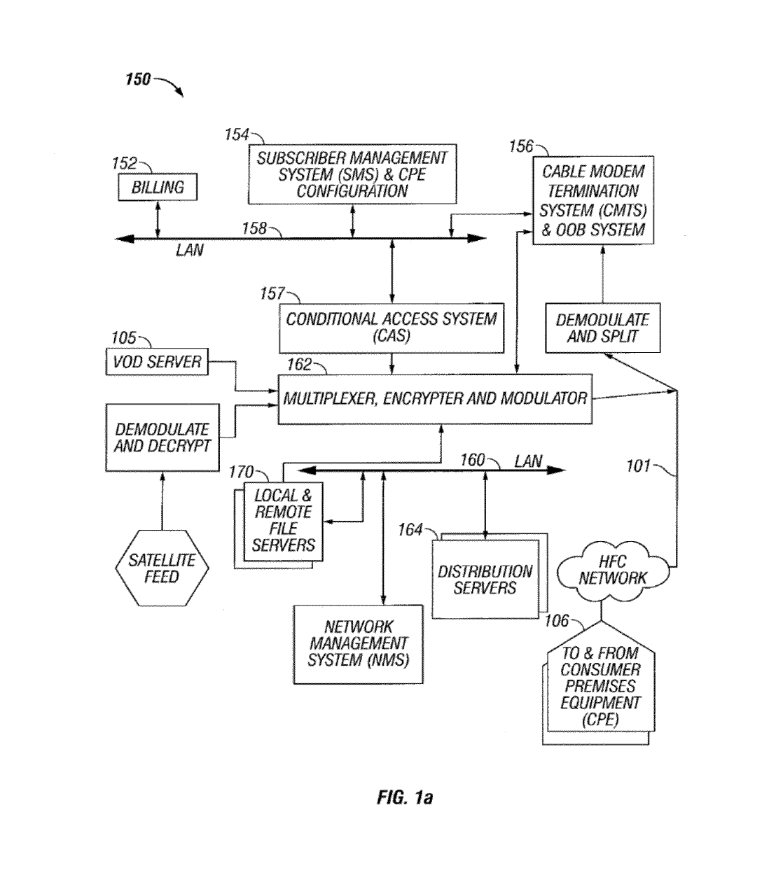

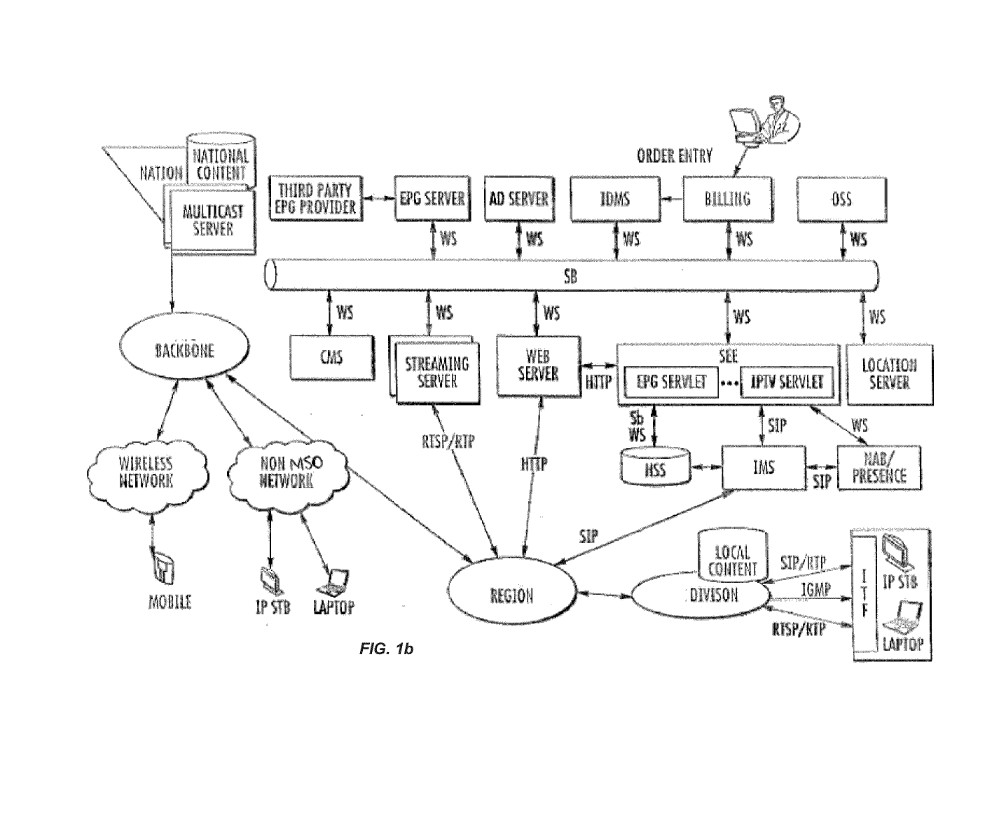

Referring now to FIG. 1, an exemplary data-over-cable (DOCSIS) network 101, including broadcast IP (e.g., IPTV) service, is shown. As can be appreciated, this network 101 may comprise merely a portion of a larger content distribution network architecture, such as for example a cable delivery network.

A “master” headend 150 is connected with one or more local nodes 104 via a network 101. The network 101 could for example comprise an optical fiber network of the type known in the art using dense wave-division multiplexing (DWDM), Synchronous Optical Network (SONET) transport technology or gigabit Ethernet transport. In the downstream direction (from the headend servers or nodes to the CPE 106), this network performs the function of carrying digital and analog television signals as well as packetized data (e.g., IP) traffic. A cable modem termination system (CMTS) 156 located at a local node 104 provides connectivity to the CPE 106 via the coaxial drop 108. However it is appreciated that the CMTS 156 may alternatively be located at the master headend 150 (as illustrated in FIG. 1a below). A cable modem (CM) 111 is used to interface with the CMTS 156 to provide DOCSIS connectivity for any premises IP video devices (IVDs) 221, such as PCs, IP-enabled televisions, or the like. The CMTS interfaces 156 in turn are connected directly or indirectly to the Internet or IP backbone (e.g., a MAN, WAN, or internet 105), thereby providing access for the CPE 106 to the Internet (or other internets, intranets, or networks) via the cable network infrastructure. Alternatively or in tandem, the headend 150 is connected to one or more such outside networks (not shown), thereby providing connectivity for the CPE 106 and headend components.

Aggregation of content such as television programs that include local and regional programming, or other types of content, occurs at the headend 150, where these programs are converted into a suitable transport format and a “channel line-up” is created for delivery to the downstream CPE 106.

Referring now to FIG. 1a, one exemplary embodiment of a general headend architecture useful with the present disclosure is described. As shown in FIG. 1a, the headend architecture 150 comprises typical headend components and services including billing module 152, subscriber management system (SMS) and CPE configuration management module 154, and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used consistent with the disclosure. The headend architecture 150 may also include the CMTS 156 if desired.

It will also be appreciated that the headend configuration depicted in FIG. 1a is high-level, conceptual architecture and that each MSO may have multiple headends deployed using custom architectures.

The architecture 150 of FIG. 1a further includes a multiplexer/encrypter/modulator (MEM) 162 coupled to the HFC network 101 adapted to “condition” content for transmission over the network. The distribution servers 164 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the headend must be adapted to acquire the information for the carried channels from various sources. Typically, the channels being delivered from the headend 150 to the CPE 106 (“downstream”) are multiplexed together in the headend and sent to neighborhood hubs via a variety of interposed network components.

Content (e.g., audio, video, etc.) is provided in each downstream (in-band) channel associated with the relevant service group. To communicate with the headend or intermediary node (e.g., hub server), the CPE 106 may use the out-of-band (OOB) or DOCSIS channels and associated protocols. The OCAP 1.0 (and subsequent) specification provides for exemplary networking protocols both downstream and upstream, although the disclosure is in no way limited to these exemplary approaches.

It will be noted with respect to FIGS. 1-1a, the CPE 106 is intended to include without limitation both legacy devices 106A (such as traditional settop boxes) as well as IP video devices (IVDs) 106B. A legacy device in the present context is a CPE 106A which is not IP enabled, but rather receives video stream from an RF or other such connection. An IVD 106B (described in greater detail subsequently herein) comprises a device which receives video streams via an IP-based transport (which may or may not be RF/coaxial connection; e.g., IP-over-DOCSIS, or over a CAT-5 TSP cable, wireless interface, etc.). These different types of devices may be hereinafter referred to collectively as “client devices”.

### “Packetized” Networks

While the foregoing network architectures described herein can (and in fact do) carry packetized content (e.g., IP over MPEG for high-speed data or Internet TV, MPEG2 packet content over QAM for MPTS, etc.), they are often not optimized for such delivery. Hence, in accordance with another embodiment of the present disclosure, a “packet optimized” delivery network is used for carriage of the packet content (e.g., IPTV content) when the request issues from an MSO network. FIG. 1b illustrates one exemplary implementation of such a network, in the context of an IMS (IP Multimedia Subsystem) network with common control plane and service delivery platform (SDP), as described in co-pending U.S. Patent Publication No. 2001/0703374 and PCT International Patent Application No. PCT/US2010/054850 entitled “METHODS AND APPARATUS FOR PACKETIZED CONTENT DELIVERY OVER A CONTENT DELIVERY NETWORK”, incorporated herein by reference in its entirety. Such a network provides significant enhancements in terms of common control of different services, implementation and management of content delivery sessions according to unicast or multicast models, quality-of-service (QoS) for IP-packetized content streams, service blending and “mashup”, etc.; however, it is appreciated that the various features of the present disclosure are in no way limited to any of the foregoing architectures.

### Content Distribution Network Architecture

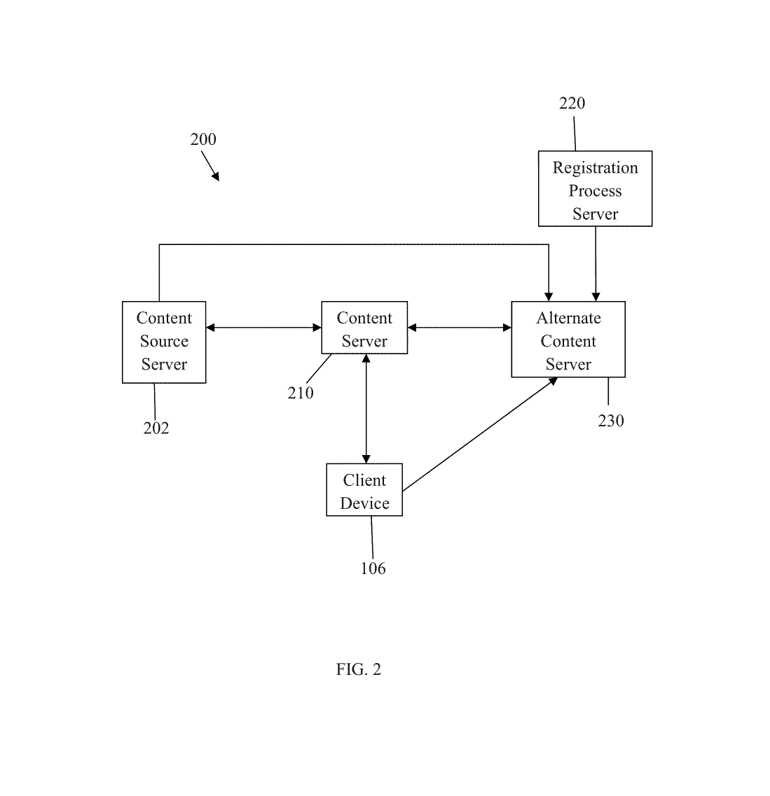

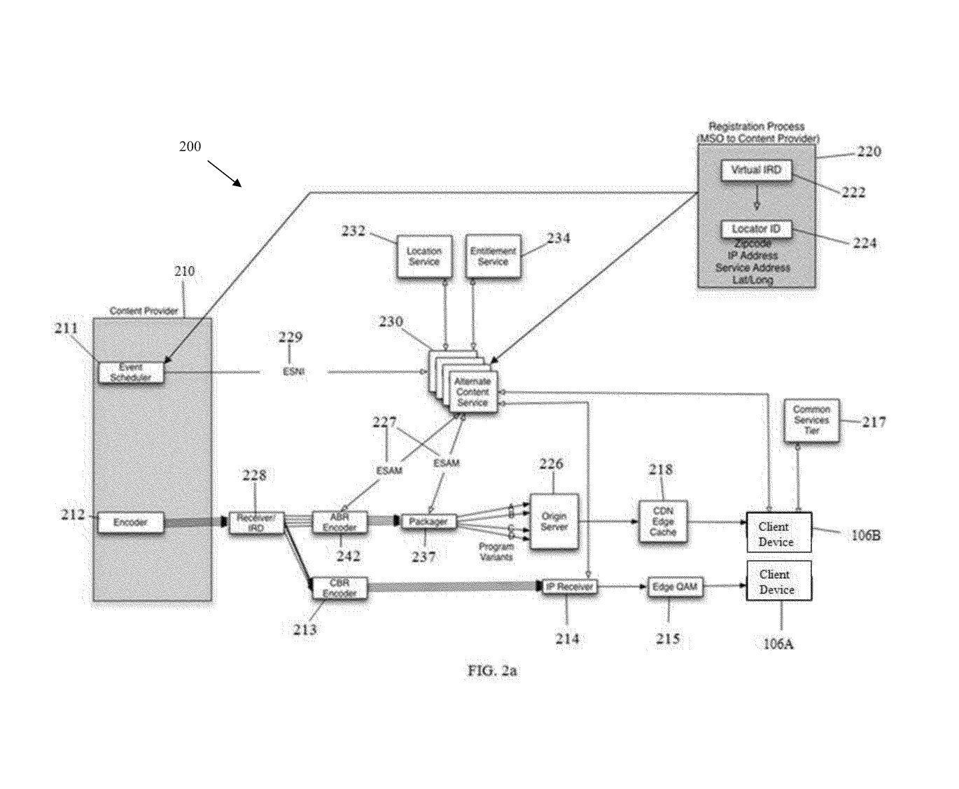

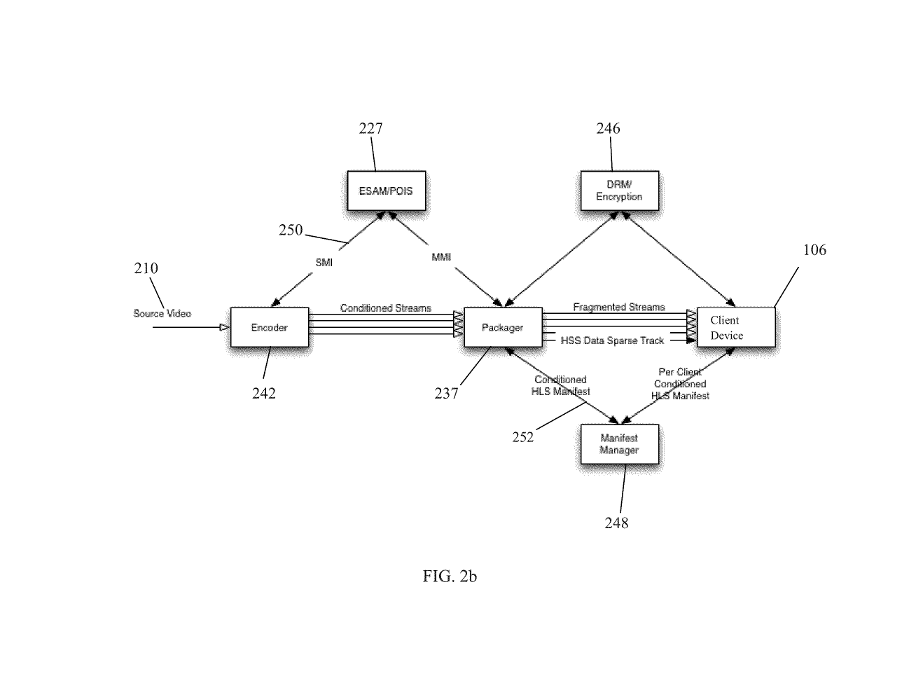

An exemplary content distribution network architecture is illustrated in FIG. 2, which operates in conjunction with the in-band and IP content systems described above. The content distribution network architecture provides, inter alia, an architecture for registering a client device to a location. When the client device requests content, the content distribution network architecture 200 applies alternate content rules to both IP delivered services and QAM delivered services. The illustrated implementation allows for terrestrial IP distributions of both adaptive bitrate (ABR) and constant bitrate (CBR) content for delivery to a requesting device.

As shown, the content distribution network architecture of FIG. 2 in one embodiment may be located at the headend 150, the local node 104, or the CMTS 156 of FIG. 1. In another embodiment the network 200 may comprise a separate entity in communication with the headend 150, the local nodes 104, and the CMTS 156.

The network 200 illustrated in FIG. 2 generally comprises one or more servers and at least one client device 106. In one embodiment, the servers comprise a content source server 202, a content server 210, a registration process server 220 and an alternate content server (ACS) 230. The registration process server 220 is responsible for associating respective locations to each of the client devices 106. In one embodiment, the association of a location to a particular device comprises first associating each of a plurality of virtual integrated receiver/decoders (vIRD) to respective headend identifiers (or some other appropriate identifier). The headend identifier is used in the exemplary implementation to register a certain set of the client devices 106 (which may be as few as one device) to a given service area or “zone”. In other words, each client device is associated to a vIRD (based on it accessing the particular vIRD), which are each in turn associated to respective headend identifiers based on service area or “zone”. In another embodiment, the devices may be associated to respective ones of integrated receiver/decoders (IRD), which are each associated to respective headend identifiers (or some other appropriate identifier). The service areas or “zones” may be represented as a list of zip codes relating to the geographic area covered thereby. However, other mechanisms may also be used to parse the plurality of subscriber devices into “zones” such as, designated market area (DMA).

Once the client devices 106 are registered the registration information is sent to the content server 210 and/or the ACS 230. The content server 210 (or ACS 230) uses the registration information to create a dynamic list, which allows the content server 210 to know the service area associated to each of the particular client devices 106. In the instance the ACS 230 does not have the requisite information, the content server 210 may publish the dynamic list so that it may be accessed and/or stored at the ACS 230, as will be described in more detail elsewhere herein.

The content server 210 receives content from the content source server 202. The content provided comprises at least a primary content (which may be subject to a blackout in some service areas) and an alternate content (which replaces the blacked out content in the given service areas). The primary content and the alternate content are marked at their boundaries (such as with a start mark and a stop mark). As discussed in greater detail elsewhere herein, in one embodiment, the markers comprise well known SCTE-35 markers, however other indicators or flags may be used with equal success. For example, the program boundaries themselves may be utilized as content flags or markers which are sufficient for the purposes of the present disclosure. The markers may be embedded into the content prior to sending both the primary content and the alternate content to the ACS 230.

In another alternative, the content server 210 is further configured to create a list (as described above) which associates a location to each of the client devices 106. The content server 210 associates a service area (or location) to each of the devices by creating a cross-reference list or mapping of the headend identifiers to service area; referred to as a “location list”. The content server 210 then publishes the list to at least the ACS 230. The content server 210 may also create a second list (separate from the above described list) which comprises a cross-reference list or mapping of the headend identifiers to an appropriate primary and alternate content, based on the viewing rights for each service area by the headend identifier; referred to as an “alternate content list”. The content server 210 publishes the second list in addition to the first list to at least the ACS 230. Both lists are dynamically updated on a periodic basis and/or whenever an event notification is needed (such as when primary or alternative content is added or removed, when one or more devices register in new service areas, etc.). The network 200 further comprises a content source 202, which sends content to the content server 210.

As noted above, the content markers may comprise SCTE-35 markers as disclosed in American National Standard-ANSI/SCTE 35 2012, Digital Program Insertion Cueing Message for Cable, by © Society of Cable Telecommunications Engineers, Inc. 2012, which is incorporated herein by reference in its entirety. The SCTE-35 marker defines the cue messages that are embedded in the primary content and the alternate content. The SCTE-35 marker also defines upcoming splice points and other timing information. However, other mechanisms for indicating positions within both the primary content and secondary content for a switch may be utilized as well (including for example, segmenting the content, marking a private data field in the MPEG stream, manifest marking, video comparison tools, watermarking, etc.).

The aforementioned markers may enable automated switching from the primary content to the alternate content. In other words, the marker (whether SCTE-35 or otherwise) triggers the ACS 230 to automatically switch the primary content to the alternate content when the client device 106 requests the primary content. This may occur via one or more components and/or servers within the network 200 which process the primary content and, when a marker is detected (i.e., when the primary content is identified as restricted or “blacked out”), is prompted to cross-reference the location and alternate content lists discussed above. Information stored in the lists enables the network components to identify whether the requesting device is among the devices which should have the requested (primary) content or alternate content delivered thereto, and in the instance it should have alternate content provided thereto, determine the appropriate alternate content for the requesting device.

In another alternative, the ACS 230 (or another server in the network 200) merely references the list and sends to the client device 106 the appropriate alternate content, the device itself is charged with performing the aforementioned switching when the marker is encountered.

The ACS 230 may further be configured to, in one exemplary embodiment, log the changes within the network 200 and ensure the schedule files within the dynamic list are followed, as well as retain a history of any additional second locations. The ACS 230 also receives updates on each of the client devices 106 added to the network 200. In another embodiment, the ACS 230 may use an audit server, such as a Linux's SYSLOG function, to log the changes within the network 200, ensure the schedule files within the dynamic list are followed, retain a history of any additional second locations, and/or receive updates on each of the client devices 106 added to the network 200.

As will be discussed below with respect to FIG. 2a, the ACS 230 may further use an event schedule and notification interface (ESNI) 229 to receive live feeds of the primary content from the content server 210. In this embodiment, the ACS 230 processes the live feeds of the primary content and analyzes them for any markers indicating that the primary content may be restricted, and then crossreferences this against the aforementioned location and alternate content lists. Accordingly, the ACS 230 is further configured to execute additional encoding within the ACS 230 to determine “on the fly” whether a requesting client device 106 is associated to a location which is entitled to receive the content, and if not what (if any) alternate content is appropriate to provide in place of the requesting content.

In another embodiment, the ACS 230 is further configured to process updates to the location and/or alternate content lists. For example, schedule files for static updates to the primary content and/or the alternate content are received and processed. When the schedule files contain static files with scheduled switches, the ACS 230 parses and approves the static files prior to accepting updates to the dynamic list. Location lists may be updated to account for newly registered devices and re-registration of devices to a new service area.

In yet another embodiment, the ACS 230 is further configured to receive a tuning request from the content server 210, or an encoder 242 or a packager 237. Based on the request, the ACS 230 references the location and/or alternate content list to determine the appropriate alternate content and either sends alternate content to the encoder 242 to be encoded, or to the packager 237 to be conditioned, or directly to the client device 106 to be viewed.

The ACS 230 may further generate log files of all switching activity (i.e., the content switches from the primary content to the alternate content) whether occurring at the ACS 230 or the devices themselves. The log files may include e.g., a channel number, a time stamp when the content switch took place, and any source information. The log file may also include a running log of all the switches in a format containing a pre-switch configuration of the primary content and a post-switch configuration of the primary content, the state of the alternate content for both pre-switch and post-switch, and both the primary content and the alternate content pre and post-switch time stamped with a resolution of at least 0.1 seconds. The log files may then be pushed from the ACS 230 to an external audit server within the network 200.

The external audit server may use the log files to aid in troubleshooting a switch and/or to validate successful switching (such as from the primary content to the alternate content, or back from the alternate content to the primary content, or other content). The external audit server may also provide compliance information and/or historical information to the content server 210, the content source server 202 and/or an operator regarding troubleshooting and successful switching.

In yet another embodiment, the ACS 230 references information regarding the primary content and based at least on this information is further configured to add new alternate content. In this embodiment, the ACS 230 may receive the information from the content server 210, or may determine itself that the primary content (e.g., restricted or “blacked out”) is delayed, cancelled or overrunning its scheduled time. In response, the ACS 230 provides the newly added alternate content to the client device 106. The newly added alternate content may comprise localized paid for content specific to the client device's service area or interstitial programming (e.g., upcoming programming). In one variant, the newly added alternate content requires the ACS 230 to either reference the alternate content list and select another (different) alternate content, which may or may not be appropriate for the client device's service area or the ACS 230 may use another alternate content, which the content source provider 202 has provided.

In the instance primary content is not to be displayed to a requesting device, the display thereof may instead revert to a “slate” (or black) screen. The slate screen may be displayed purposefully and/or upon a network error. For example, the slate screen may be displayed when the ACS 230 and/or another server in the network 200 fails to provide the client device 106 with the appropriate alternate content.

In another embodiment, the client device 106 allows for manual intervention on any appropriate alternative content. The manual intervention may include enabling an operator to manually complete switching from the primary content to the alternate content, and/or manually insert the alternate content when the automated switching from the primary content to the alternate content has failed. The operator may also start and stop the alternate content for such cases as when the primary content (e.g., restricted or “blacked out”) is delayed, cancelled or overrunning its schedule time. In the case where the primary content is overrunning its scheduled time, the operator may start a new alternate content when the switched-to alternate content ends. In the case where the break in the primary content ends early, the operator may stop the alternate content and switch back from the alternate content to the primary content. The operator may also modify or remove the marker (whether SCTE-35 or otherwise), which triggers the ACS 230 to automatically switch the primary content to the alternate content, in the cases where the primary content is no longer restricted or “blacked out” for a particular service area. In yet another embodiment, the manual intervention may include enabling the user to access the alternate content list and replace the alternate content provided to the client device 106 with another appropriate alternative content (e.g., localized paid-for content, interstitial programming, etc.). The manual intervention may further include enabling the user to enable closed captioning, descriptive audio and/or subtitles. In yet another embodiment, the ACS 230 may be further configured to have a login function, which allows the content source server 202 (e.g., content providers) to login and manually intervene as discussed above.

FIG. 2a is another exemplary content distribution network architecture configured in accordance with the present disclosure. In this embodiment, the content distribution network 200 further comprises the registration process server 220 which enables devices (106A and 106B) to be associated to a network entity, such as e.g., a virtual integrated receiver/decoder (vIRD) construct 222. The vIRD creates a set of data by associating the client devices 106A, 106B to a location. An advantage of the vIRD construct 222 is that it allows for centralized distribution of feeds over a terrestrial IP network.

The vIRD construct 222 in one embodiment creates the aforementioned data set by assigning each client device 106A, 106B a respective vIRD; this may be accomplished e.g., by providing a headend identifier for each vIRD and associating each device to a vIRD (such as when each device attempts to access content through a vIRD). Each vIRD headend identifier is then associated to a service area (such as via the aforementioned location list). In another embodiment, the vIRD construct 222 further comprises assigning the vIRD and/or the service area to appropriate primary and/or alternate content, such as by creating the aforementioned alternate content list.

In another embodiment, the registration process server further comprises a location device (not shown). The location device causes the client device 106 to provide the client device's location (e.g., registered location, as discussed above) when the client device 106 is using a proxy device (e.g., a proxy server). The location device upon receiving the client device's location validates the location and the registration process server 220 may then continue to associate the client device 106 to a network entity, as discussed elsewhere herein.

In yet another embodiment the registration process server 220 further comprises a locator ID 224. The locator ID 224 communicates and works in conjunction with the vIRD construct 222 to assign the client device to the vIRD (headend identifier) and then to an appropriate service area. For example, the vIRD construct 222 assigns the client devices 106A, 106B to the appropriate vIRD headend identifier. This information is then communicated to the locator ID 224, which in turn associates each headend identifier to a service area. The locator ID 224 associates service areas to the headend identifiers by zip code, IP address, service address, GPS coordinates, etc. to generate the location list. Once the location list has been derived, the vIRD construct 222 and locator ID 224 further cooperate to associate the service areas to particular the primary and alternate content (thereby generating the alternate content list). The completed location list and alternate content list are transmitted to at least the content server 210 and the ACS 230.

The generated data lists allow the content server 210 to know the geographic identifier for each client device 106A, 106B and therefore ensure that only appropriate content is provided thereto (particularly in the instance where the geographic location of the device does not match the location to which the device is registered).

As discussed above with respect to the generalized network embodiment, the lists are used to cross-reference locations to appropriate content. The location and alternate content lists may be provided as one or more lists to the ACS 230. On a periodic basis (and/or whenever an event notification is needed), new lists are published. In another embodiment, a WebServices interface may be used to publish the dynamic list to the network 200. In yet another embodiment, the lists may be published (or “pushed”) each time there is an update. Still further, other servers in the network 200 may be configured to pull the dynamic list to themselves.

The content server 210 as described supra, further comprises in one embodiment an event scheduler 211. The event scheduler 211 creates a schedule including a start time and a stop time for the primary content subject to a blackout, and the alternate content which should replace the primary content in some service areas. The event scheduler 211 may use an event schedule and notification interface (ESNI) 229 to publish (“push”) the schedule to the ACS 230. Alternatively, the schedule may be published on a periodic basis (whenever an event notification is needed).

The content server 210 in another embodiment is further configured to mark the primary content and the alternate content with the start mark and the stop mark as discussed above. The marks allow the ACS 230 upon receipt of the primary content and the alternate content to automatically switch the primary content to the alternate content when the client devices 106A, 106B do not have the viewership rights for the primary content based on the client devices 106A, 106B service areas. In one embodiment the content server uses the SCTE-35 marker, as described above, to be used for both QAM applications and IP/ABR/CBR delivery applications. Alternatively, an encoder 212, may mark the primary content and the alternate content with start and stop markers. It is appreciated however, that any combination of the aforementioned components may be used to mark one or more of the alternate content and/or primary content. The encoder 212 further encodes the content using a desired codec for an MP4 format. The encoder 212 then transmits the primary content and the alternate content to a receiver 228. The receiver 228 then transmits the primary content and the alternate content to at least an ABR encoder 242 or a CBR encoder 213, or both.

In one embodiment the ABR encoder 242 encodes the primary content and the alternate content into an adaptive bitrate stream. The ABR encoder 242 then uses an event scheduling and management interface (ESAM) 227 to transmit the primary content and the alternate content to the ACS 230. Alternatively, the primary content and the alternate content may be instead provided to a packager 237 for further processing and conditioning.

The packager 237 encapsulates the primary content and the alternate content into an application protocol format. In one embodiment, the application protocol format comprises a hypertext transfer protocol (HTTP) format. In another embodiment, the application protocol format comprises HTTP live streaming (HLS). According to this embodiment, the marking on the primary content indicates to automatically switch the primary content for the alternate content. The packager 237 then uses the ESAM 227 to transmit the alternate content to the ACS 230, or to transmit the content to an origin server 226. In yet another embodiment the application protocol format comprises smooth streaming (HSS) format. According to this embodiment, the marker indicates for a sparse track to be created, which indicates that the primary content is automatically switched for the alternate content. The packager 237 then uses the ESAM 227 to transmit the alternate content to the ACS 230 or to transmit the content to an origin server 226. The origin server 226 can then determine whether to send the primary content or the alternate content (e.g., appropriate content) by referencing the dynamic list. Once the appropriate content is determined (either primary content or alternate content), it is transmitted to an edge cache 218 or the client device 106B.

The packager 237 may be further configured to register and publish URLs for the primary content and the alternate content on behalf of the network 200. The servers 230, 210, 220 in one embodiment update the dynamic list by associating the URLs to the primary content, the alternate content and the second location of the client devices 106A, 106B.

In another embodiment the CBR encoder 213, may process the primary content and the alternate content to a constant bitrate, single program transport stream multicast in order to support services or features such as e.g., Start-Over, Look Back, switched digital video, etc. According to this embodiment, when a marker is encountered by the IP receiver 214, it triggers the IP receiver 214 to contact the ACS 230 and provide the headend identifier associated to the requesting IP receiver 214 thereto. Alternatively, an intermediary entity may be provided an identifier of the requesting device (such as MAC address, IP address, subscriber account information, etc.) and identify the appropriate headend identifier associated to the requesting device. Based on the headend identifier, the ACS 230 determines the service area (such as by cross referencing the location list) and indicates the appropriate SPTS multicast(s) (primary content or alternate content) to send to the IP receiver 214 (by cross referencing the alternate content list). The foregoing may be accomplished by first registering the IP receiver 214 to a headend identifier at the ACS 230 in a manner similar to the registration of the client devices 106 registered to a registration process 220 as described elsewhere herein. In addition, as opposed to a headend identifier, the IP receiver 214 may instead be associated via a management interface IP address, a media access control address (MAC), or other identifier. The IP receiver 214 may use an interface (such as e.g., an SCTE-130 interface) to signal back to the ACS 230 to determine the multicast program (primary content or alternate content) to provide. The client device 106A tunes, via its RF tuner, to an edge QAM 215 (as shown in FIG. 2a) to receive the appropriate content, as the IP receiver 214 acts as a gateway for the network 200. The IP receiver 214 continues to switch to the appropriate content as defined by the service area for the client device 106A.

FIG. 2b is another embodiment for processing and conditioning the primary content and the alternate content. The encoder 242 and the packager 237 comprise two separate entities in this embodiment, however it is appreciated that in another embodiment, a single entity may perform both functions. Additionally, the encoder 242 transmits the primary content and/or the alternate content which has been marked as discussed above to indicate appropriate start and stop points for switching (where necessary) to a placement opportunity information system (POIS) 227. The POIS 227 analyzes the marked content for validity and transmits back to the encoder 242 either a validation message or an invalidation message.

If it is determined that the markers are validly placed, the POIS 227 also transmits information (metadata) describing the markers, such as positioning thereof within the primary and/or the alternate content, duration between markers, etc. The metadata is utilized by the encoder 242 to identify and update the start mark and the end mark for the primary content and/or the alternate content. The POIS 227 may also transmit information such as a duration time for the primary content and/or the alternate content, which the encoder 242 may also use to e.g., condition or process the primary content and/or the alternate content. The POIS 227 may also transmit auxiliary data to be inserted into the primary content and/or the alternate content for use by downstream components. The auxiliary data is processed according to specific application requirements for each downstream component. The packager 237 submits a message to the POIS 227 indicating processing is of the previously validated content markers is completed. The POIS 277 then transmits in response manifest-specific conditioning instructions back to the packager 237 which are inserted into the primary content and/or the alternate content on behalf of the network 200.

In the instance that the one or more markers within the primary and/or alternate content are not validated, the POIS 227 transmits an error and instruction message to the encoder 242 and/or packager 237 which enact appropriate corrections. In this instance, the encoder 242 may generate a slate static content (e.g., a black screen), and/or a message (i.e., a notification for the reason why an error occurred). The packager 237 may then encapsulate the slate static content, and/or the message into an application protocol format and transmit the slate static content, and/or the message to the ACS 230, and/or to an origin server 226. The ACS 230 and/or the origin server 226 transmit the slate static content, and/or the message to the client device 106 as discussed elsewhere herein. In another embodiment, when one or more markers within the primary and/or alternate content are not validated, the POIS 227 transmits an error and instruction message to an operator, who may validate one or more markers within the primary and/or alternate content.

In another embodiment a signal confirmation and conditioning (SMI) application programming interface (API) 250 can be used between the encoder 242 and the POIS 227. In this embodiment, the encoder 242 receives the primary content and/or the alternate content which has been marked. The encoder 242 transmits the marked primary and/or alternate content using a payload to the POIS 227 for validation. The payload may use a JavaScript object notation (JSON), which is a lightweight data-interchange format. Alternatively, an extensible markup language (XML), which is a markup language that defines a set of rules for encoding, may be used. The POIS 227, upon analyzing the start and end markers of the primary content and/or alternate content, transmits via the SMI 250 placement opportunity metadata to the encoder 242. The POIS 227 derives information about the start marker and the stop marker for the primary content and/or alternate content with the corrected coordinated universal time (UTC), normal play time (NPT), and/or SCTE 35 point data. Specific markers (e.g., CableLabs 3.0 Signal IDs) may also be obtained. Finally, the POIS 227 transmits information detailing how the encoder 242 might condition the primary content and/or the alternate content to the encoder 242. As noted above, the POIS 227 may also provide auxiliary data to be inserted for downstream components.

In yet another embodiment a manifest confirmation and conditioning (MMI) API 252 may be used for communication between the packager 237 and a manifest manager 248. The packager 237 transmits a request with the payload and the validated markers to the manifest manager 248. In one embodiment, the request is sent via HTTP POST and the payload comprises either JSON or XML. In response to receiving the request, the manifest manager 248 provides information regarding the validated markers. For example, a marker may be a splice out/exit mark as indicated by an SCTE 35 splice_info_section( )/splice_insert( ) command, or the marker may be an SCTE 35 segmentation_descriptor( ). In addition, the manifest manager 248 transmits information detailing how the packager 237 may condition the primary content and/or the alternate content and the associated manifest files. The manifest manager 248 may also provide auxiliary data to be inserted for downstream components to identify the marks.

The manifest manager 248 supports at least two different forms of HLS manifest conditioning: (i) media segment modification mode (segment modify), and (ii) media segment replacement mode (segment replace). The packager 237 submits the payload and the stop mark (which, for example might be identified by a URL) to the manifest manager 248. The packager 237 receives in response a media segment modification or replacement mode. The media segment modification mode, i.e., segment modify, describes changes to the primary content and/or alternate content when only a subset of the HLS media segments are enhanced. The media segment replacement mode, i.e., segment replace, indicates the manifest manager 248 returned a set of content segments that are to directly replace an existing segment of the primary content and/or alternate content.

In one embodiment, when the client devices 106A, 106B do not support a segment of the primary content and/or alternate content, then that segment is ignored. For example, in one embodiment, if the client device 106A, 106B does not support the Microsoft® Smooth sparse track/fragment insertion feature, the segment is ignored. Alternatively, the content may be checked by the client device 106A, 106B or the ACS 230, for device compatibility prior to delivery and be re-encoded, etc. as needed.

In one exemplary embodiment, the methods and apparatus of CableLabs® ESAM technical overview OpenCable™ Specifications-Alternate Content, Real-time Event Signaling and Management API, by © Cable Television Laboratories, Inc. 2012, which is incorporated herein by reference in its entirety, may be utilized. As discussed therein, the apparatus comprises two interfaces that are used either for mark processing and stream conditioning or for manifest conditioning. The first interface allows the encoder 242 to submit signals to the POIS 227 and receive content conditioning data and directives; while the second interface allows submission of a validated marker and receipt of manifest manipulation instructions.

In addition, the network (and/or network 200) for processing and conditioning the primary content and the alternate content may be further comprised of one or more signal acquisition systems. For example, the network 200 may further comprise a transcoder, which submits the markers (which for example may be SCTE 35 splice insert messages), to the POIS 227. The POIS 227 confirms the validity of the markers (as discussed elsewhere herein) and returns information allowing the transcoder to identify and update the start marker or end marker of the primary content and/or the alternate content. The POIS 227 also may return relevant information such as a duration time for the primary content and/or the alternate content that can be used for conditioning the primary content and/or the alternate content being encoded. The POIS 227 may also return additional information such as auxiliary data to be inserted into the primary content and/or the alternate content for downstream components, which can consume and process the auxiliary data according to the specific components requirements.

The auxiliary data may include multimedia content such as scores, statistics, advertisements, slate static content (e.g., a black screen), and/or other relevant information regarding the primary content and/or the alternate content. The auxiliary data may be formatted using Enhanced TV Binary Interchange Format (EBIF), such as that described in U.S. patent application Ser. No. 12/582,653 filed on Oct. 20, 2009 entitled “METHODS AND APPARATUS FOR ENABLING MEDIA FUNCTIONALITY IN A CONTENT-BASED NETWORK”, which is now published as U.S. Patent Application Publication No. 2011/0090898, and patented as U.S. Pat. No. 8,396,055 on Mar. 12, 2013, which are incorporated herein by reference in its entirety, and discloses inter alia one or more interactive media applications configured to utilize the EBIF. The client application running on the client device 106 may comprise an EBIF user agent. The user agent enables the user of the client device 106 to view and interact with various EBIF pages of the particular media application(s) of interest. In one exemplary embodiment, one or more interactive media applications may be generated using the auxiliary data and displayed at the client device 106 as the primary and/or alternate content.

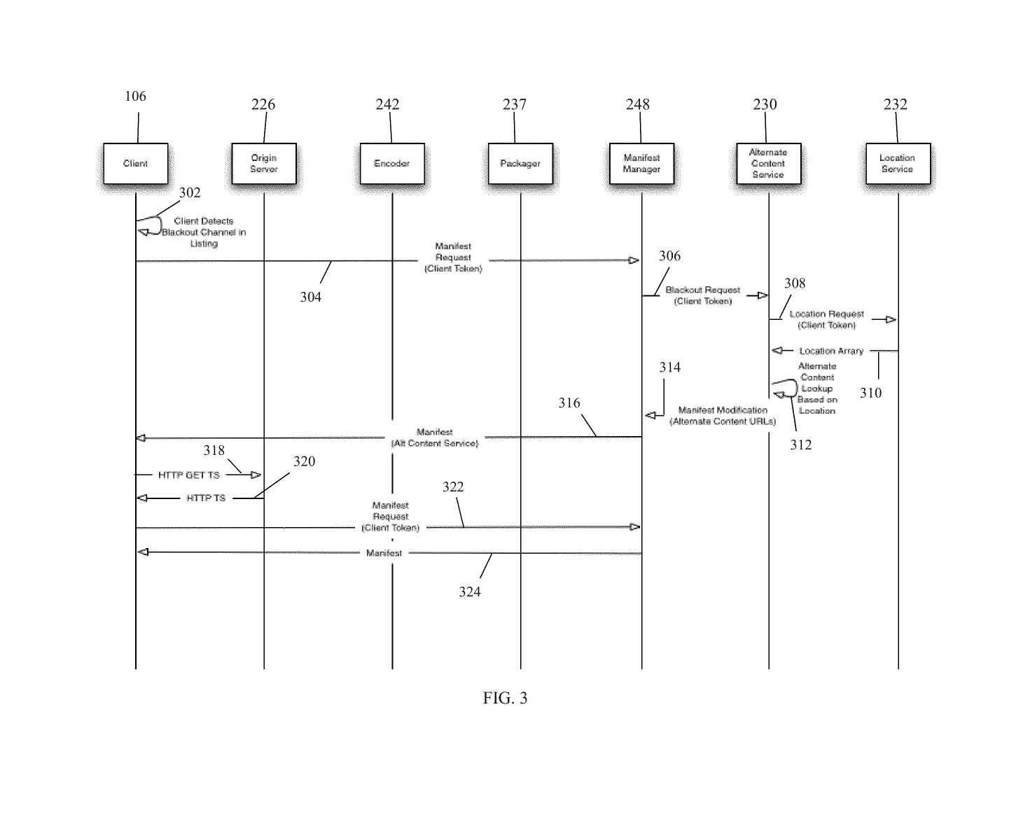

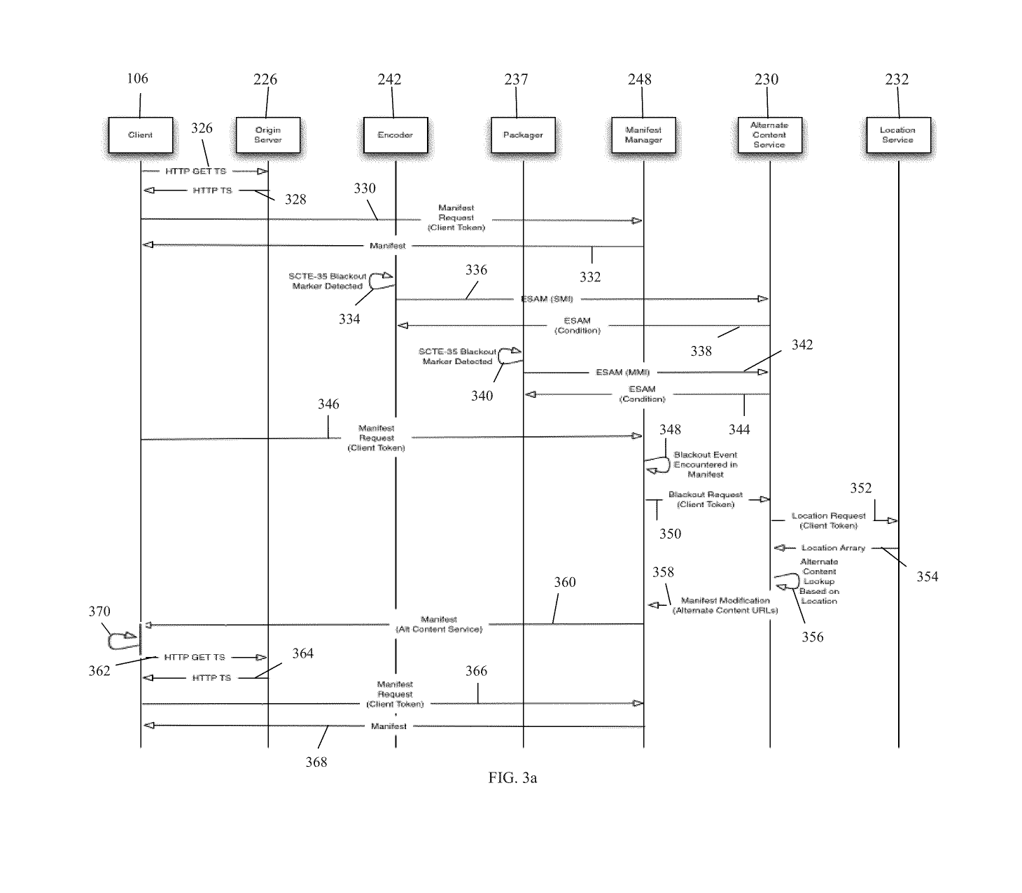

Referring now to FIG. 3 another exemplary embodiment for HLS initial tune message flow when the client device 106A, 106B supports HLS streaming is illustrated. The apparatus and methods of HTTP Live Streaming Overview, Apr. 1, 2011, © 2011 by Apple Inc., which is incorporated herein by reference in its entirety, may be utilized. As discussed therein, the primary content and/or the alternate content for HLS streaming is either marked as described above or the primary content is listed as content to be restricted for specific service areas and the alternate content is listed as the content to replace the primary content. In this embodiment, the client device 106A, 106B is directed to the ACS 230 to retrieve a manifest needed for the HLS streaming. The manifest returned is based on the client devices 106A, 106B service area and the content determined to be appropriate to be viewed by the device (primary content or alternate content) when a request to view the primary content is received. The client device 106A, 106B passes a client token (which for example may be a wayfarer token) with the request to help the ACS 230 determine the service of the client device 106A, 106B in one embodiment.

FIG. 3 outlines the messaging flow for an initial tune of the client device 106 to the primary content, which is restricted for that device. As shown, the client device 106 detects the primary content as restricted in a listing (which for example may comprise a portion of the aforementioned alternate content list), via a pathway 302, which prompts the client device 106 (or a designated proxy, such as a premises gateway) to send a request, via a pathway 304, with a client token to the manifest manager 248 to retrieve a manifest needed for the service. The manifest manager 248 forwards the request (including the client token) via a pathway 306 to the ACS 230. The ACS 230 then sends a location request with the client token, via a pathway 308, to a location service 232. It will be appreciated that as used herein, the term “location” is broadly interpreted to include information which is not purely geographic or literal in nature, but rather may also include information that more indirectly identifies a given location or association with a known location of a device, service, etc.

The location service 232 sends a location array, via a pathway 310, to the ACS 230, and the ACS 230 cross references the manifest, via a pathway 312, to look up the appropriate alternate content based on e.g., the location sent by the location service 232. In one embodiment, the location refers to the service area discussed herein. The ACS 230 then sends a modified manifest, which includes at least the alternate content URLs to the manifest manager 248, via a pathway 314. The manifest manager 248 then sends the manifest with the alternate content, via a pathway 316, to the client device 106. The client device 106 then contacts the origin server 226, via a pathway 318. The client device 106 may use an HTTP GET TS command to contact the origin server 226, via the pathway 318. The origin server 226 sends a response (e.g., an HTTP TS response) to the client device 106, via a pathway 320, instructing the client device 106 to contact the manifest manager 248. The client device 106 then sends to the manifest manager 248 the manifest request with the client token, via a pathway 322. The manifest manager 248 then sends to the client device 106 the appropriate manifest, via a pathway 324.

Another exemplary embodiment is shown in FIG. 3a, which outlines the messaging flow for an event occurring during the viewing of primary content for an HLS client on a restricted channel. In this embodiment, the client device 106 sends an HTTP GET TS command, via a pathway 326, to the origin server 226. The origin server 226 sends an HTTP TS response, via a pathway 328, to the client device 106 to contact the manifest manager 248. The client device 106 then sends the manifest request with the client token, via a pathway 330, to the manifest manager 248. The manifest manager 248, after receiving the request, sends the manifest, via a pathway 332, to the client device 106. The marker (which for example may be the exemplary SCTE-35 blackout marker) is detected at the encoder 242, via a pathway 334, and the encoder 242 configured to use the ESAM interface 227 (as shown in FIG. 2a) to transmit the primary content and/or the alternate content to the ACS 230, via a pathway 336. The ACS 230 responds by sending the appropriate primary content and/or alternate content to the encoder 242, via a pathway 338. When the marker is detected at the packager 237, via a pathway 340, the packager 237 is configured to use the MMI interface, as described above, to transmit the detected marker to the ACS 230, via a pathway 342. The ACS 230 validates the mark and transmits the validation to the packager 237, via a pathway 344. The client device 106 then sends the manifest request with the client token, via a pathway 346, to the manifest manager 248. When it is encountered that the primary content is restricted, the manifest manager 248 sends a request for the alternate content with the client token, via a pathway 350, to the ACS 230. The ACS 230 then sends the location request with the client token, via a pathway 352 to the location service 232.

The location service 232, in response to the location request, sends the location array, via a pathway 354, to the ACS 230. The ACS 230 then uses the location list and/or alternate content list to correspond the appropriate alternate content to the location array sent from the location service 232, via a pathway 356. The ACS 230 then sends to the manifest manager 248 a modified manifest with the alternate content, via a pathway 358. The alternate content may be identified via a URL. The manifest manager 248 sends the manifest, which includes the alternate content to replace the primary content, to the client device 106, via a pathway 360. Once, the alternate content has ended (as identified via a stop or end marker, via a pathway 370) the client device 106, upon receiving the manifest, sends the HTTP GET TS command to the origin server 226, via a pathway 362. The origin server 226 responds with the HTTP TS command to the client device 106, via a pathway 364, to contact the manifest manager 248. The client device 106 then sends the manifest request with the client token, via a pathway 366, to the manifest manager 248. The manifest manager 248 responds by sending the client device 106 the manifest, via a pathway 368. The message flow as shown in FIG. 3a continues as described above whenever the alternate content ends and new primary content begins or until the client device 106 is turned off.

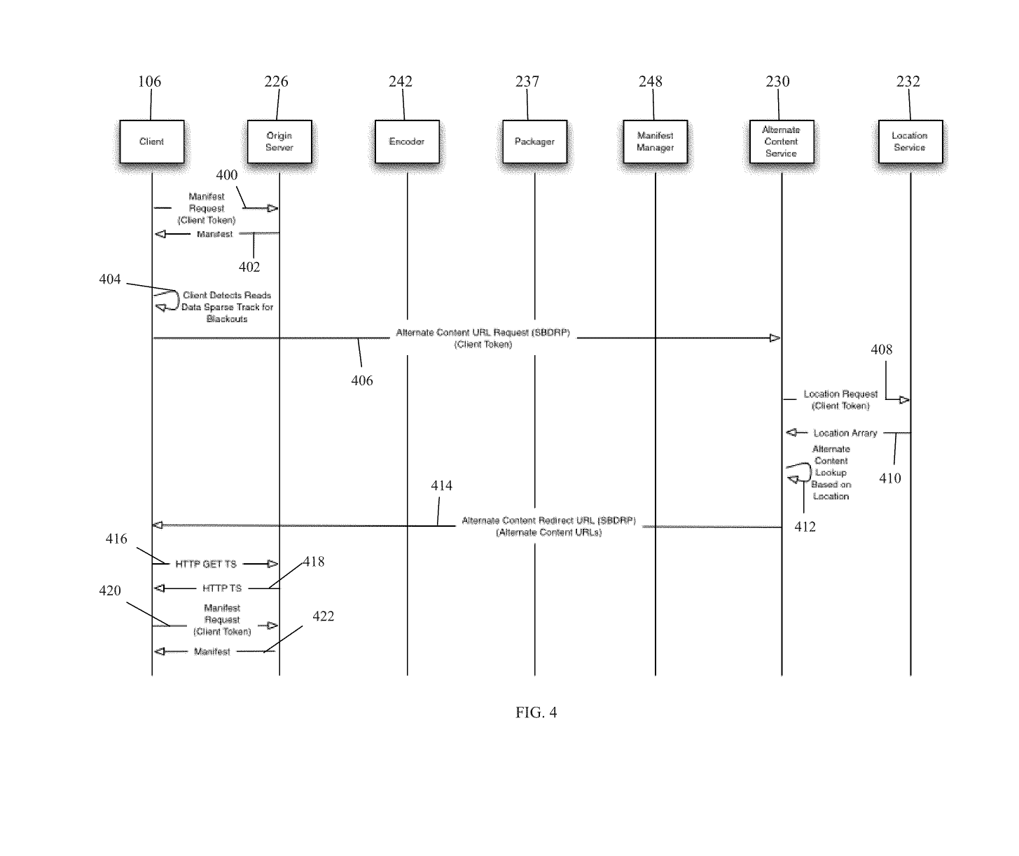

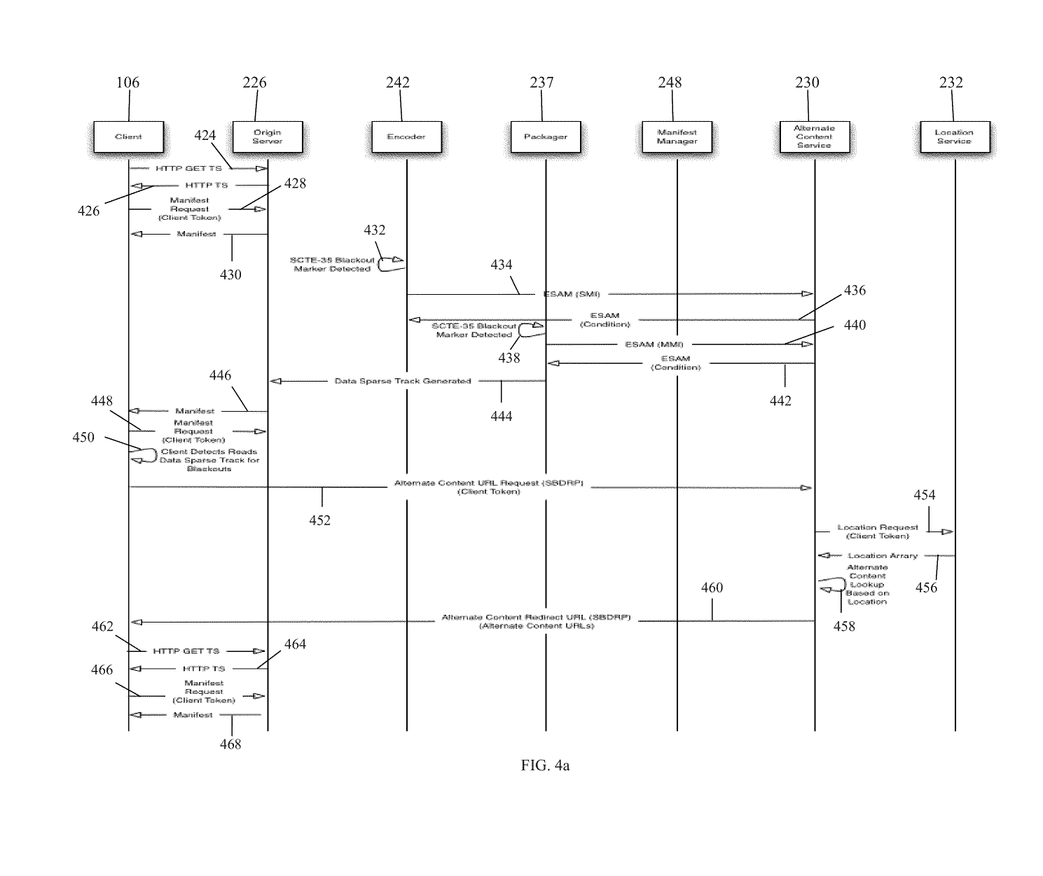

FIG. 4 illustrates another exemplary embodiment for HSS initial tune message flow when the client device 106A, 106B supports HSS streaming. The apparatus and methods of IIS Smooth Streaming Technical Overview, by Alex Zambelli, March 2009, © 2009 Microsoft Corporation, which is incorporated herein by reference in its entirety, may be utilized. As discussed therein, for initial tune one of the servers in the network (such as network 200 of FIG. 2b) reads the manifest for the primary content and/or the alternate content to detect the presence of the marker. In one embodiment, the marker comprises a data sparse track. In this embodiment the client device 106 is directed to the ACS 230 to retrieve the appropriate alternate content. The appropriate alternate content returned is based on the determined service area of the client device 106. Furthermore, the client device 106 utilizes the data sparse tracks as indications of when the primary content is restricted. The data sparse tracks indicate to the client device 106 to send a request to the ACS 230 for the appropriate content.

As shown in FIG. 4, the client device 106 sends the manifest request with the client token, via a pathway 400, to the origin server 226. The origin server 226 responds by sending the manifest to the client device 106, via a pathway 402. The client device 106 detects the presence of the marker (which for example may comprise data sparse track; see discussion above) indicating that the primary content is restricted, via pathway 404, and immediately sends a request for the alternate content with the client token to the ACS 230, via a pathway 406. The ACS 230 upon receipt of the request sends the location request with the client token, via a pathway 408, to the location service 232. The location service 232 responds by sending the location array to the ACS 230, via a pathway 410. The ACS 230 then looks up the appropriate alternate content, via a pathway 412, based on the location array sent by the location service 232. The ACS 230 then sends the alternate content to the client device 106, via a pathway 414. As noted elsewhere herein, the alternate content may be identified via a URL. The client device 106 upon receipt sends the HTTP GET TS command to the origin server 226, via a pathway 416. The origin server 226 responds by sending the HTTP TS command back to the client device 106, via a pathway 418. The client device 106 upon receipt of the HTTP TS command sends the manifest request with the client token, via a pathway 420, to the origin server 226. The origin server 226 then sends the manifest, via a pathway 422, to the client device 106.

Another exemplary embodiment is shown in FIG. 4a illustrating the client device 106 utilizing the data sparse tracks to indicate that the primary content is restricted and when new primary content is also restricted. In this embodiment, the client device 106 sends the HTTP Get TS command to the origin server 226, via a pathway 424. The origin server 226 sends in response the HTTP TS command, via a pathway 426, to the client device 106. The client device 106 then sends the manifest request with the client token, via a pathway 428, to the origin server 226. The origin server 226 sends the manifest to the client device 106, via a pathway 430. The encoder 242, via a pathway 432, detects the marker (which for example may be an SCTE-35 marker), which prompts the encoder 242 configured to use the ESAM interface 227 to transmit the primary content and/or the alternate content to the ACS 230, via a pathway 434. The ACS 230 responds by sending the appropriate primary content and/or alternate content to the encoder 242, via a pathway 436.

When the marker is detected at the packager 237, via a pathway 438, the packager 237 configured to use the MMI interface, as described above, to transmit the detected marker to the ACS 230, via a pathway 440. The ACS 230 validates the marker and transmits the validation to the packager 237, via a pathway 442. The data sparse track is then generated and sent from the packager 237 to the origin server 226, via a pathway 444. The origin server 226 then sends the manifest to the client device 106, via a pathway 446, and the client device 106 sends the manifest request with the client token to the origin server 226, via a pathway 448. When the client device 106 detects the data sparse track, via a pathway 450, the detection prompts the client device 106 to send the request with the client token, via a pathway 452, to the ACS 230. In one embodiment, the request for the alternate content may comprises a request which includes a URL identifying the alternate content. The ACS 230 then sends the location request with the client token, via a pathway 454, to the location service 232. The location service 232 sends in response the location array to the ACS 230, via a pathway 456. The ACS 230 then looks up the alternate content, via a pathway 458, based on the location array sent by the location service 232. The ACS 230 after looking up the alternate content sends the alternate content to the client device 106, via a pathway 460. Again, it is recognized that the alternate content may be identified and/or accessed via a URL. Upon receipt of the alternate content (or by accessing the URL) the client device 106 sends the HTTP GET TS command, via a pathway 462, to the origin server 226. The origin server in response sends the HTTP TS command to the client device 106, via a pathway 464. The client device 106 then sends the manifest request with the client token, via a pathway 466, to the origin server 226. The origin server 226 in response sends the manifest to the client device 106, via a pathway 468. The message flow as shown in FIG. 4a continues as described above whenever the alternate content ends and new primary content begins or until the client device 106 is turned off.

### Exemplary Methods

### Registration and Association

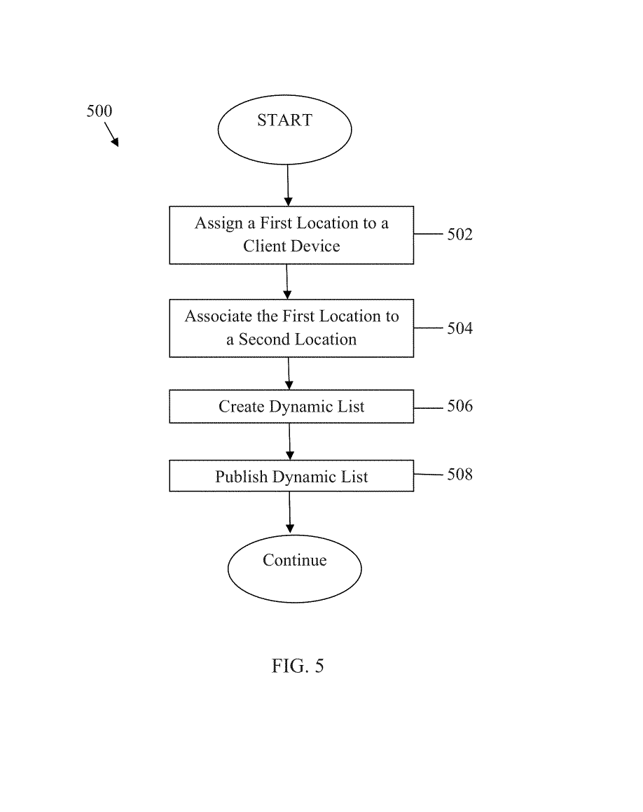

Referring now to FIG. 5, an exemplary embodiment of a method 500 for registering the client device 106 to a first location identifier (such as e.g., a headend identifier as discussed above) and associating the first location identifier to a second location value (such as e.g., a service area, zip code, or other geographic region) according to the disclosure is shown.

Per step 502, a server assigns the first location to the client device 106. In one embodiment, the server comprises the registration process server 200, which assigns a headend identifier (or other identifier) to the client device 106. In another embodiment, the server comprises the vIRD construct 222, which assigns the first location identifier to the client device. The assignment of the first location identifier may comprise assignment of one of the following identifiers: network identification, address information, as well as geographic location information such as, a zip code, latitude/longitude, GPS coordinates, etc. to each of the devices 106. In one embodiment, the first location identifier of the client device 106 is assigned by associating each device 106 to a vIRD which is assigned an identifier (such as one of the above mentioned identifiers). In another embodiment, the first location identifier of the client device 106 is assigned by associating each device 106 to an IRD which is assigned an identifier (such as one of the above mentioned identifiers). In yet another embodiment, the client device 106 are each themselves assigned one of the above mentioned identifiers.

Next, per step 504, the server associates the first location identifier to the second location value. In one specific embodiment, the server associates a headend identifier of each vIRD, IRD, and/or client device 106 to a given service area or zone. In this manner, a particular set of the client devices 106 (which may be as few as one device) are grouped by e.g., zip codes, geographic area, demographics, etc. In another embodiment, the service area or “zone” comprises a combination of at least two of the above mentioned identifiers of step 502. In one embodiment, the server forwards the client devices and their associated first location identifier and second location value to another server to perform the remainder of the method 500.

Next, per step 506, the server creates the location list and alternate content list. The server which creates these lists may comprise the content server 210 and/or the ACS 230. This allows each of the servers in the network to know which of the client devices 106 are associated to each of the groups (e.g., service areas, geographic areas, zip code ranges, etc.) and which content to provide (primary or alternate content) when primary content is requested. The server creates the location list by associating the client devices 106 to second location values. The server associates the primary content and the alternate content to second location values in order to create the alternate content list. In this embodiment, the servers within the network know the second location for the client devices 106 and the primary content and the alternate content for each of the second locations. In yet another embodiment, the server the aforementioned alternate content list may further include information relating to when the primary content and the alternate content starts and stops. Information relating to the duration of the primary content and/or the alternate content may also be included.

Lastly, at step 508, the server publishes the generated lists to the other servers in the network 200 for later use thereby as discussed elsewhere herein. In one embodiment, the content server 210 publishes the lists using the ESNI interface 229 (as described above) to be accessed by e.g., the ACS 230. In another embodiment, the dynamic lists are updated on a periodic basis by at least one of the servers in the network 200 and published to the other servers within the network 200 periodically.

### Signal Processing

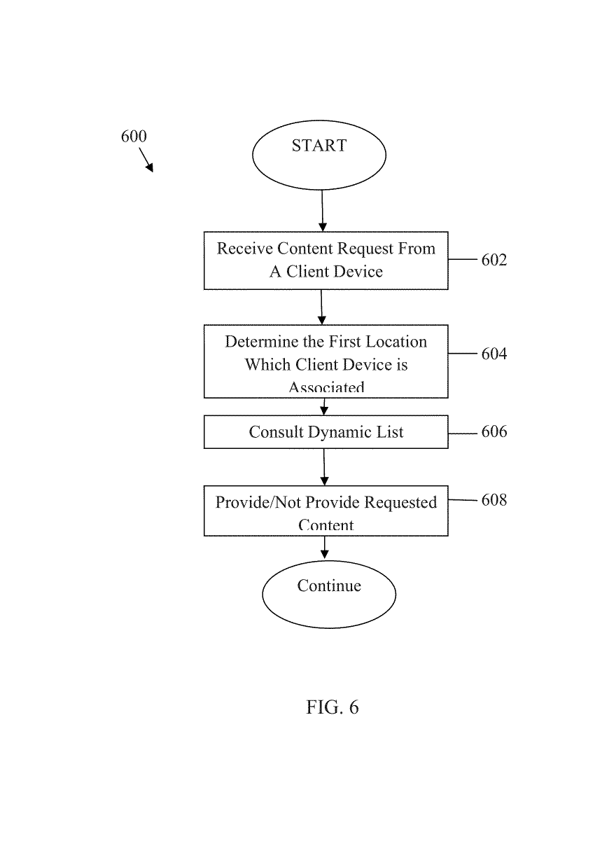

Referring now to FIG. 6, an exemplary embodiment of a method 600 for providing either the primary content or the alternate content to the client devices 106 according to the disclosure is shown.

Per step 602, at least one of the servers receives a request for the primary content from the client device 106. The request from the client device 106 is transmitted to the ACS 230 and/or the content server 210. In the instance the content server 210 is used, the request is either forwarded to the ACS 230 on behalf of the client device 106 or the content server 210 responds to the client device 106 instructing the client device to contact the ACS 230.

Next per step 604, the server (which for example may be the ACS 230) determines the first location identifier of the client device 106. As noted above, this may comprise consulting another server (which for example may be the location service 232) and the location list. A location array including the location identifier of the requesting device 106 may be provided in one embodiment. Other server resources may be consulted as well for information including e.g., registration information (in one example an entitlement service server 234 may be consulted). The information is then transmitted to the original requesting server (e.g., the ACS 230).

Next per step 606, the server (which for example may be the ACS 230) consults the alternate content list to determine a relationship between the location of the requesting device and the appropriate content therefor, which comprises either the primary content or the alternate content.

Lastly, per step 608, based on the results of consulting the location list and/or alternate content list, the server (which for example may be the ACS 230) provides the client device 106 with the appropriate content (either the originally requested primary content, or alternate content selected to replace the primary content for the location of the requesting device).

The primary and/or alternate content may comprise e.g., a movie, TV show, live programming, etc. In addition, the alternate content may comprise infomercials and/or advertisements specific to the service area of the client device 106, slate static content (e.g., a black screen), a message (i.e., a notification for the reason why the primary content is restricted), or alternate live programming. A myriad of other content formats and types are appreciated, the foregoing being merely exemplary in nature.

### Alternate Content Server (ACS)

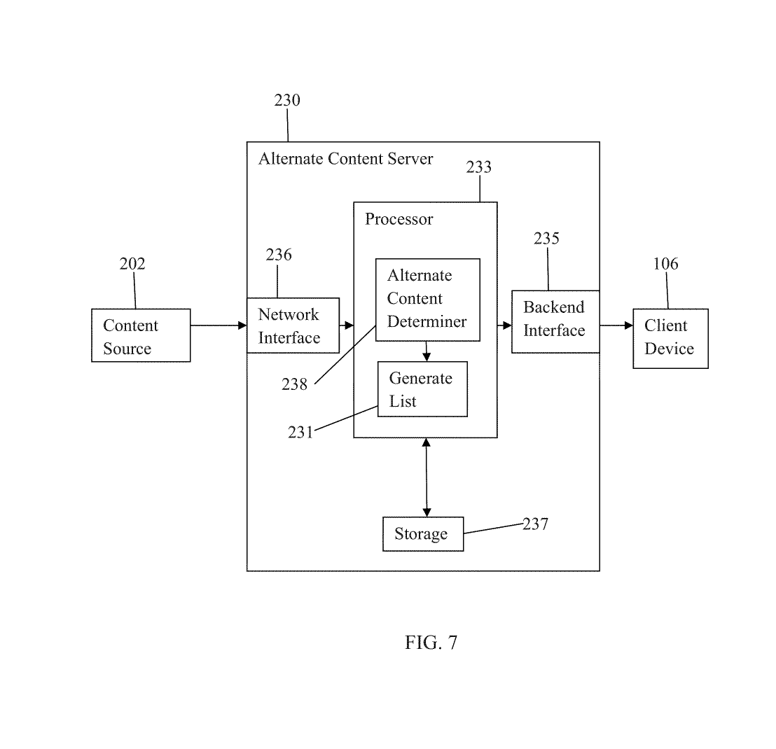

As shown in FIG. 7 is an exemplary embodiment of the ACS 230. The ACS 230 comprises a network interface 236, which receives both the primary content and the alternate content from the content source 202 or the content server 210. The network interface 236 is also configured to receive requests from the client device 106, and forward these requests to a processor 233.

The processor 233 is configured to communicate with a storage device 237, where the storage device 237 comprises at least one computer program executable on the processor 233. The computer program comprises a plurality of instructions which are configured to, when executed, determine the first location identifier for the client device 106. In one embodiment, the computer determines the first location identifier by obtaining information and/or identifiers from the client device 106 when the client device 106 sends the request. The information and/or identifiers may comprise at least one of the following: network identification, address information, as well as geographic location information such as, a zip code, latitude/longitude, GPS coordinates, etc. The computer program uses the information to assigns the client device 106 to a vIRD or IRD (each individually associated with first location identifiers). In yet another embodiment, the computer program uses the information received as the first location identifier for the client device 106.

The computer program then associates the first location identifier of the client device 106 to a second location value, the second location value in one embodiment comprises a service area or other geographic grouping. In another embodiment, the second location value represents a broader geographic area than the first location identifier. For example, when the first location identifier is associated to a zip code, the second location value may be representative of an area code, or county or information that more indirectly identifies a given location or association with a known location of a device, service, etc., which is broader than the geographic region identified by the first location identifier.

The computer program then creates the location list comprising an association of the first location identifiers of the client devices to each of the second location values. The computer program further creates the alternate content list by associating second location values to each of the primary content and/or alternate content. One or more of the lists may further include the start time and the stop time of the primary content and/or the alternate content based on the start marks and the stop marks in the primary content and the alternate content and/or the duration of the primary content and/or the alternate content. The computer program then distributes the lists to the network 200 and/or stores the dynamic list in the storage 237.

In another embodiment the computer program is configured to, when executed, receive the request for primary content at the network interface 236. Then the program determines the first location identifier of the client device and either determines the second location value of the client device or cross-references the location list to identify the second location. The computer program is then able to determine the appropriate content to send to the client device based on the second location value of the client device by either contacting another server (which for example may be the entitlement service server 234) or cross-referencing the alternate content list. The appropriate content (either the primary content or the alternate content) is then sent to the requesting client device 106 via a backend interface 235.

### Legacy Architecture

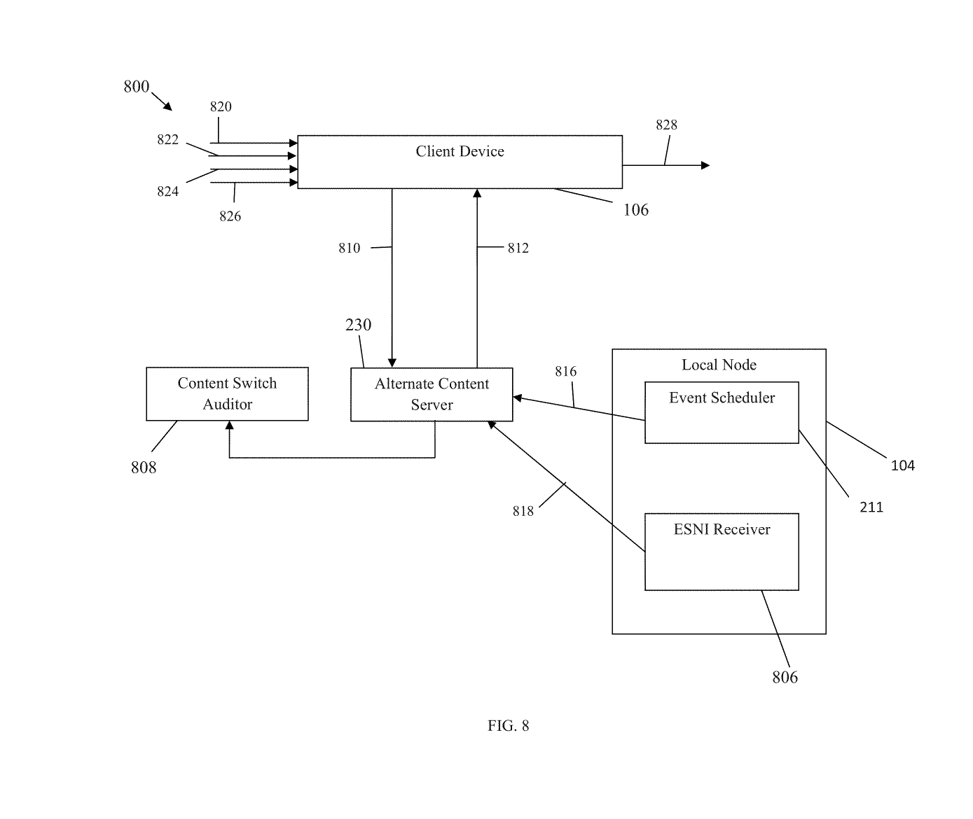

An exemplary legacy architecture configurable with the present disclosure is illustrated in FIG. 8.

The network 800 as shown in FIG. 8, in one embodiment may be located at, and in communication with, the master headend 150, the local node 104, the CMTS 156, and/or the network as shown in FIGS. 1 and 2. In another embodiment, the network 800 is a separate entity in communication with the master headend 150, the local nodes 104, the CMTS 156, and the network 200. In yet another embodiment, the network 800 is an extension of the network 200.

As shown in FIG. 8, the network comprises the client device 106, which receives the primary content and the alternate content from the content provider, via a pathway 820. The primary content and the alternate content when received by the client device 106 can also be referred to as an input stream. Furthermore, the client device 106 in this embodiment is further configured to include a linear stream switcher. When the client device 106 discovers that the input stream of the primary content is marked (as being content to which a blackout or alternate content switch may apply), the client device 106 sends a content switch request, via a pathway 810, to the ACS 230. The client device 106 may alternatively send the content switch request to another server within the network 200 (which for example may be the content server 210).

The request in one embodiment comprises at least a channel name or number, and/or a multicast reference source (S), group source (G), and/or port source (P). In another embodiment, the client device 106 uses in-band (which for example may be SCTE35-2012) to communicate with the ACS 230 and/or other servers within the network 200 when transmitting the content switch request. The content switch request may further include a channel name, a number, and acquisition information (in this case, source IP, Multicast Group IP and UDP port). The ACS 230 or another server within the network 200 cross-references the content switch request with the location and/or alternate content lists and tune data which the ACS 230 receives from the local node 104. An event scheduler 211 at the local node 104 transmits the location and/or alternate content list and tune data, via a pathway 816, to the ACS 230 as described above. One or more of the lists may further comprise the tune data, which allows the event scheduler 211 to transmit a single unitary and all inclusive piece of information to the ACS 230.

The local node 104 further comprises an event schedule and notification interface (ESNI) server 806 in one embodiment, which transmits to the ACS 230 the tune data, via a pathway 818. The ESNI server 806 can reside at the local node 104 as a separate server within the network 200, 800. The ACS 230 also receives tune data from the local node 104. The ACS 230 then cross-references the first location identifier of the client device 106, which the ACS 230 received when the client device 106 requested the content switch, to the location list, the alternate content list, and the tune data to determine the appropriate alternate content for the client device 106. The ACS 230 then sends a retune message, via a pathway 812, to the client device 106, where the retune message includes at least the channel name and/or number multicast S, G, P. The client device 106 then retunes to the appropriate alternate content.

The client device 106 retunes from the primary content to the alternate content, via the pathway 820 or via a pathway 822, where the pathway 820 and the pathway 820 share the same input port. The client device 106 then outputs the alternate content, via a pathway 828, to a display device for the user. In one embodiment, the client device 106 presents a visual notification to a user prior to displaying the alternate content that the primary content is restricted and being switched to the alternate content. The notification may be sent, via a simple network management protocol (SNMP). The ACS 230 in one embodiment is further configured to comprise a content switch auditor (CSA) 808, which stores and reports the content switches. The CSA 808 may alternatively comprise a separate entity either residing in another server in the network 200, 800 or as separate server in the network configured to communicate with the other network components. In the embodiment where the CSA 808 is separate from the ACS 230, the ACS sends a “push” notification, via a pathway 814, to the CSA 808, where the CSA 808 stores and reports the content switch.

In one exemplary embodiment a live switch is signaled when the marker (which for example may be a SCTE 35-2012 PID splice) appears in the primary content. The client device 106 messages the ACS 230; the message comprises at least one of the following: a content identifier, the channel number, a source IP, a Multicast group and/or a user datagram protocol (UDP) port. The ACS 230 responds with the retune message (stream identifier, new channel name, new channel number, source, group, port) and a transaction identifier for the client device 106 to switch to the appropriate alternate content, via one of the pathways 820, 822, 824. According to this embodiment, the primary content and the alternate content are on the same input port. The ACS 230 in one embodiment also transmits the retune message with at least one of the following: time, stream identifier, channel name, channel number, source, group, port, transaction ID, and/or status to the CSA 808.

In another exemplary embodiment, when the client device 106 detects the marker in the primary content, the client device 106 sends to the ACS 230 the current status of the primary content (that is, the client device 106 is instructing the ACS 230 where the client device 106 receives the primary content), the channel name, and the request for the retune message. When the response contains a reference to retune to the alternate content that does not exist, or there is no response from the ACS 230 or other server providing the alternate content, the client device 106 retunes to a slate display.

In yet another embodiment, the ACS 230 or another server in the network 200 is further configured to reference the alternate content list and send to the client device 106 the appropriate alternate content e.g., syndication over runs where it is required to not show the primary content due to rights mismatches, for that particular second location.

Still further, the ACS 230 may query the client device 106 for the first location identifier to determine the second location value associated with the client device 106. According to this embodiment, the ACS 230 responds with the retune message, which comprises the tuning information (channel identifier, new channel number, source, group, port) and the transaction ID and transmits the retune message to the client device 106 and/or the CSA 808. The CSA 808 may transmit a request to confirm the content switch in response. The ACS 230 compares the content switch to the location and/or alternate content list and responds to the CSA 808 a pass or a fail on the content switch from the primary content to the alternate content.

The network 800 may be further configured to allow for automated switching from the primary content to the alternate content. In other words, the components and/or servers within the network 800 process the primary content and detect the marker, e.g., indicates the primary content is restricted, which prompts the component and/or server to cross-reference the location and/or alternate content lists and switch the primary content to the alternate content where appropriate. The component and/or server perform the above-mentioned process without communicating with other components or servers within the network.

The alternate content may further include a program identifier (PID), which is a different PID than a standard advertisement insertion PID. It should be noted that the switch from the primary content to the alternate content is seamless, such that any PID referenced in the primary content (video, audio, PSI, PSIP, SCTE35, DVB or other) is referenced in a program mapping table (PMT) even though it is not being used. Furthermore, the switching PID is referenced in the PMT of the primary content and the alternate content. Also, the PMT table version number cannot change, and continuity counters (CC's) for the video and audio PIDs also cannot be discontinuous on outputs (i.e., the pathway 828) that are used on the client device 106. Where an output PID is missing from the new primary content in the client device 106, the CC may start at any value but be continuous from that point on.

It is further appreciated that in another embodiment, the content switches may have a unique 32 bit identifier for each content switch and the output of the primary content and/or the alternate content may have a 16 bit unique stream identifier set by the ACS 230 or another server in the network 800. In yet another embodiment, the network 800 is configured to allow the servers within the network 800 to use a Evertz data embedder to push advertisement splice notices into uncompressed alternate content so that a DPI PID has available in the alternate content to include an extended descriptor in the SCTE35-2012 message for the alternate content. The extended descriptor allows the encoder in a high-definition serial digital interface (HD SDI) stream to generate a new PID that has the messages isolated.

The primary content and/or the alternate content may further include a SCTE-35 splice format descriptor in the PMT. The splice format descriptor may include a splice exact option to ensure the switch matches the alternate content list. The primary content may need an independent PID with the marking separate from the alternate content advertisement insertion PIDs. In yet another exemplary embodiment, the primary content and the alternate content are on the same physical input port of the client device 106. The primary content contains any PIDs that are referenced in the PMT and the alternate content contains any PIDs that can be present on the primary content. Also, the primary content may have 0.15 seconds of black frame going into or coming out of the alternate content. In yet another embodiment, the audio may also be muted on both the primary content and the alternate content going into and out of the client device 106. In yet another embodiment, where a dialnorm is applicable, the dialnorm settings on the primary content and the alternate content are identical.

The ACS 230 may be further configured to include additional functionalities including e.g., an ability to process live feeds of the primary content. In this embodiment, the ACS 230 analyzes the primary content for any markers indicating that the primary content is blacked out for the client device 106 based on the second location value of the client device 106. In yet another embodiment, the ACS 230 provides logs showing the receipt of the primary content and/or the alternate content from the content server 210 along with time stamps associated with the receipt of the primary content and/or the alternate content with at least a minimum resolution of 0.1 seconds.

As noted above, the client device 106 may receive a slate to visually present error conditions, including e.g., the ACS 230 and/or another server in the network 800 failing to provide the client device 106 with the alternate content. The client devices 106 may also enable manual intervention (as discussed above) on any appropriate alternative content.

The client device 106 may further utilize an interface to push content switch notifications to an external audit interface and may provide a log file of all content switches from the primary content to the alternate content, including the channel number, the time of the switch, the source information, and the response from the ACS 230. In this embodiment the log file may also include a running log of all the switches in a format containing a pre-switch configuration of the primary content and a post-switch configuration of the primary content, the state of the alternate content both pre-switch and post-switch, and both the primary content and the alternate content pre and post-switch time stamped with a resolution of at least 0.1 seconds. The client device 106 logs may also include SNMP traps for failed switches.

The client device 106 may be further configured to, in accordance with requirements from the content source provider, announce losses of the switching PID reference in the PMT of the primary content and the alternate content to the network 200. When the alternate content terminates without a retune indication, the client device 106 can announce a loss of signal to the network 200 and display the slate as noted above. Also as noted above, the primary and/or alternate content may be provided in a multicast or unicast UDP stream containing valid MPEG2 transport stream packets, with the blacked out primary content PID stripped from the output.

In another embodiment the client device 106 is further configured to include at least one of the following a tracking number; a VCT/Network ID (legacy IRD constructs that may be required by programmers); an authorization state (authorized, awaiting approval, deauthorized); a status (active switched, active original); an alternate content tuner (tune to alternate content); a retune tuner (go back to original content); a channel name (human readable string); a stream identifier (16 bit exclusive channel ID); a program number; a PID presence input (listing of PIDs expected on input); and/or a PID presence output (listing of PIDs expected on output).

The CSA 808 in one exemplary embodiment is capable of logging the changes within the network 800 and ensures the schedule files within the dynamic list are followed as well as retain a history of any additional second locations, the addition of new alternate content, and also the content switches into and out of the alternate content. The CSA 808 also receives updates on each of the client devices 106 added to the network 800, switches between the primary content to the alternate content and any manual interventions, and allows for explicit queries into its database for specific switches, monthly channel reports, provider reports and global reports.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art. The foregoing description is of the best mode(s) presently contemplated. This description is in no way meant to be limiting, but rather should be taken as illustrative of the general principles of the disclosure.

What is claimed is:

1. A method for associating individual ones of a plurality of locations to a respective plurality of client devices in a content distribution network, said method comprising:
assigning one of a plurality of first locations to respective ones of said plurality of client devices accessing said network;
associating individual ones of said plurality of first locations to respective individual ones of a plurality of second locations;
creating a dynamic list, said dynamic list comprising:
individual ones of said plurality of client devices;
a respective second location to which said individual ones of said plurality of client devices are associated; and
an indicator of viewing rights for said individual ones of said plurality client devices based on said respective second location to which each is associated; and
publishing said dynamic list to said network.

2. The method of claim 1, further comprising requesting an identifier from each of said plurality of client devices, said identifier being used in said act of assigning said one of said plurality of first locations to said respective ones of said plurality of client devices accessing said network.

3. The method of claim 2, wherein said plurality of first locations individually comprises a virtual integrated receiver/decoder (vIRD).

4. The method of claim 2, wherein said act of associating said individual ones of said plurality of first locations to respective individual ones of said plurality of second locations further comprises assigning multiple ones of said plurality of first locations to a respective one of said plurality of second locations.

5. The method of claim 1, wherein said dynamic list further comprises said assigned one of said plurality of first locations for each of said individual ones of said plurality of client devices.

6. The method of claim 5, wherein said dynamic list further comprises a primary content and an alternate content associated to each of said plurality of second locations and/or said plurality of first locations.

7. The method of claim 6, wherein said dynamic list further comprises a start time and an end time for said primary content and said alternate content.

8. A method for delivering content to a plurality of client devices in a content distribution network, said method comprising:
receiving a request for said content from at least one of said plurality of client devices;
determining a first location associated to said requesting client device;
consulting a dynamic list comprising an association of said first location to one of a plurality of second locations;
determining based on said one of said plurality of second locations an appropriate one of a plurality of content to send to said requesting client device; and
sending said appropriate one of said plurality of content to said requesting client device.

9. The method of claim 8, wherein said dynamic list further comprises a primary content and an alternate content associated to individual ones of said plurality of second locations.

10. The method of claim 9, wherein said dynamic list further comprises viewership rights associated with said primary content and viewership rights associated with said alternate content.

11. The method of claim 8, further comprising storing a plurality of data, said plurality of data comprising at least one of:
data relating to said act of sending said appropriate one of said plurality of content to said requesting client device;
data relating to said requesting client device;
data relating to said first location associated to said requesting client device; and
data relating to said one of said plurality of second locations.

12. The method of claim 8, wherein said act of determining said first location associated to said requesting client device further comprises requesting an identifier from said requesting client device and using said identifier as said first location associated to said requesting client device.

13. The method of claim 12, wherein said identifier comprises at least one of: a zip code, a latitude and longitude coordinate, a global positioning system (GPS) coordinate, and/or a user address corresponding to said requesting client device.

14. The method of claim 8, wherein act of sending said appropriate one of said plurality of content to said requesting client device further comprises encoding said appropriate one of said plurality of content into an format appropriate for said requesting client device.

15. The method of claim 8, wherein said appropriate one of said plurality of content comprises alternate content, said alternate content being pre-determined to be provided to said one of said plurality of second locations in an instance said requested content has been restricted from viewing at said requesting client device.

16. An apparatus configured to process data associated with a plurality of substantially portable client devices in a content distribution network and assign a location thereto, said apparatus comprising:
a processor;
a storage device in data communication with said processor, said storage device comprising at least one computer program, said at least one computer program comprising a plurality of instructions which are configured to, when executed:
obtain first data relating to individual ones of said plurality of client devices;
based on said first data, determine a plurality of first locations associated to respective ones of said plurality of client devices;
associate each of said plurality of first locations to a second location;
create a data record configured to indicate appropriate content viewing rights for said second location; and
distribute said data record to said network.

17. The apparatus of claim 16, wherein said plurality of instructions are further configured to, when executed:
receive a request for content from one of said plurality of client devices;
determine an individual one of said plurality of first locations associated to said one of said plurality of client devices;
cross-reference said individual one of said first locations to said data record to determine said second location; and
provide said one of said plurality of client devices with said appropriate content based on said second location.

18. The apparatus of claim 17, wherein said plurality of instructions are further configured to, when executed, generate a record of:
said appropriate content provided to said one of said plurality of client devices;
said one of said plurality of client devices;
said individual one of said plurality of first locations associated to said one of said plurality of client devices and
said second location.

19. The apparatus of claim 17, wherein said appropriate content comprises content which is pre-determined to be provided to said second location in an instance said requested content has been restricted from viewing at said requesting one of said plurality of client devices.

20. The apparatus of claim 16, wherein said first data relating to said plurality of client devices comprises an identifier, said identifier comprising at least one of: a zip code, a latitude and longitude coordinate, a global positioning system (GPS) coordinate, and/or a user address.

21. A system for delivery of content in a content distribution network, said system comprising:
a plurality of client devices, at least one of said plurality of client devices configured to request access to said content from a network; and
said network configured to:
determine a first location for said at least one of said plurality of client devices;
use a dynamic list to cross-reference said first location to a second location;
based on said second location, determine viewership rights of said at least one of said plurality of client devices; and
provide appropriate content to said at least one of said plurality of client devices, said appropriate content being selected based at least in part on said viewership rights.
